(19) United States
(12) Patent Application Publication
(10) Pub. No.: US 2015/0278027 A1
(43) Pub. Date: Oct. 1, 2015

(54) BACKUP APPARATUS, BACKUP METHOD, AND STORAGE MEDIUM THAT STORES BACKUP PROGRAM

(71) Applicant: FUJITSU LIMITED, Kawasaki-shi (JP)

(72) Inventors: Hideo Nishi, Miki (JP); Tatsushige Inaba, Osaka (JP); Yosuke NAKA, Kobe (JP); Jun Sugii, Kobe (JP); Tsuyoshi Nose, Higashiosaka (JP); Mihoko Ono, Nishinomiya (JP)

(73) Assignee: FUJITSU LIMITED, Kawasaki-shi (JP)

(21) Appl. No.: 14/619,215

(22) Filed: Feb. 11, 2015

(30) Foreign Application Priority Data
Mar. 31, 2014 (JP) 2014-072169

(51) Int. Cl. G06F 11/14; H04L 29/08

(52) U.S. Cl. CPC G06F 11/1446; H04L 67/1097; G06F 11/1464; G06F 2201/84

(57) ABSTRACT

A backup apparatus which backs up data of a management device which manages a plurality of client devices based on information from agents which correspondingly operate on the plurality of client devices, the backup apparatus includes: a memory; and a processor coupled to the memory and configured to: generate a data block related with a specific agent, from information received from the specific agent and information on a client device in which the specific agent of the asset management device operates, for each of the plurality of agents, calculates arrangement appropriateness of the plurality of client devices based on the information received from the plurality of agents, and distribute and arranges the plurality of data blocks to the plurality of client devices in accordance with the arrangement appropriateness of the plurality of client devices.

### CROSS-REFERENCE TO RELATED APPLICATION

This application is based upon and claims the benefit of priority from the prior Japanese Patent Application No. 2014-072169 filed on Mar. 31, 2014, the entire contents of which are incorporated herein by reference.

### FIELD

The embodiments discussed herein are related to a backup apparatus, a backup method, and a storage medium that stores a backup program.

### BACKGROUND

An asset management system that manages hardware and software of an information communication system of an enterprise as assets backs up the hardware and the software using a media such as a DVD, a file server of the enterprise, or an on-line storage service, as in other information communication system.

However, as compared with other information communication system, the asset management system is characterized in that a policy defined in an asset management device is distributed to an agent serving as a client device through a network. Further, the asset management system is characterized in that inventory information of the client device is collected by the asset management device through the network.

Here, the inventory information refers to information on the client device, such as a space of a disk device, an OS type, and installed software, and the policy is information on asset management, such as time when the inventory information is collected and an acquiring method of distributed software. Further, the agent serves as a client device to execute a process necessary for asset management, such as collection of inventory information, based on the policy. Further, an example of the client device includes a personal computer, a server, and a tablet device.

In the feature of the asset management system, the inventory information and the policy information managed by the asset management device are also present in individual client devices. Therefore, when data of the asset management device is broken due to a system failure, the agent transmits the inventory information and the policy information to the asset management device, so that the asset management device may restore information on the latest state of the client device.

According to a related art, in a distributed agent system in which a plurality of agents cooperatively operates, the agents cooperate with each other to record a state of their own agents and a message is received and transmitted between the agents to perform a backup.

There is a related art in which a job is divided into multiple tasks using a database and an attribute of the tasks and a load state of the agents are added to determine a role of a task process and manage the task process. There is another related art in which an agent performs a receipt acknowledgment of a trap transmitted from an agent during the management of a network by a simple network management protocol (SNMP) to precisely manage the network.

Related technologies are disclosed in, for example, Japanese Laid-Open Patent Publication No. 2003-150568, Japanese Laid-Open Patent Publication No. 11-096011 and Japanese Laid-Open Patent Publication No. 10-051476.

However, since the information managed by the asset management device includes information not possessed by the agent, such as the license information, distributed software information, system setting information, when a system failure occurs, the system may not be restored only by collecting information from the agent. Further, the client device whose asset is managed by the asset management device is not a dedicated data storage device, so that the client device is not sufficient in view of arrangement appropriateness, such as reliability, to be used for a backup.

### SUMMARY

According to an aspect of the embodiments, a backup apparatus which backs up data of a management device which manages a plurality of client devices based on information from agents which correspondingly operate on the plurality of client devices, the backup apparatus includes: a memory; and a processor coupled to the memory and configured to: generate a data block related with a specific agent, from information received from the specific agent and information on a client device in which the specific agent of the asset management device operates, for each of the plurality of agents, calculates arrangement appropriateness of the plurality of client devices based on the information received from the plurality of agents, and distribute and arranges the plurality of data blocks to the plurality of client devices in accordance with the arrangement appropriateness of the plurality of client devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view for explaining an asset management system according to an embodiment;

FIG. 2 is a view illustrating a configuration of an asset management system according to an embodiment;

FIG. 3 is a view illustrating an example of an inventory information table;

FIG. 4 is a view illustrating an example of a policy information table;

FIG. 5 is a view illustrating an example of a license information table;

FIG. 6 is a view illustrating an example of a distributed software information table;

FIG. 7 is a view illustrating an example of a login account information table;

FIG. 8 is a view illustrating an example of a software implementation detecting condition table;

FIG. 9 is a view illustrating an example of an arrangement appropriateness table;

FIG. 10 is a view illustrating an example of a grouping table;

FIG. 11 is a view illustrating an example of a restoration prohibition table;

FIG. 12 is a view for explaining generation of a data block;

FIG. 13 is a view for explaining determination of arrangement appropriateness and generation of an agent group;

FIG. 14 is a view for explaining an agent group and group data;

FIG. 15 is a view illustrating an example of meta data;

FIG. 16 is a view for explaining restoration of an asset management DB;

FIG. 17 is a flowchart illustrating a flow of a process when an asset management device is implemented;

FIG. 18 is a flowchart illustrating a flow of a process at a time of operation by an asset management device;

FIG. 19 is a flowchart illustrating a flow of a process at a time of restoration by an asset management device;

FIG. 20 is a flowchart illustrating a flow of a data block generating process;

FIG. 21 is a view illustrating an example of information which is included in each data block;

FIG. 22 is a flowchart illustrating a flow of an arrangement appropriateness determining process;

FIG. 23 is a flowchart illustrating a flow of a storage appropriateness determining process;

FIG. 24 is a flowchart illustrating a flow of a withdrawal appropriateness determining process;

FIGS. 25A and 25B are a flowchart illustrating a flow of a grouping process;

FIG. 26 is a flowchart illustrating a flow of a redundancy storing place group setting process;

FIG. 27 is a flowchart illustrating a flow of a data block updating process;

FIG. 28 is a flowchart illustrating a flow of a restoration prohibition process;

FIG. 29 is a flowchart illustrating a flow of a restoration•inventory updating process;

FIG. 30 is a flowchart illustrating a flow of a withdrawal mode clear determining process;

FIG. 31 is a flowchart illustrating a process flow when an agent is implemented;

FIG. 32 is a flowchart illustrating a process flow when an agent is operated or restored;

FIG. 33 is a flowchart illustrating a flow of a backup data receiving process; and

FIG. 34 is a view illustrating a hardware configuration of a computer which executes an asset management program according to an embodiment.

### DESCRIPTION OF EMBODIMENTS

Hereinafter, embodiments of a backup apparatus, a backup method, and a backup program disclosed in the present application will be described in detail with reference to the accompanying drawings. Further, the embodiments do not limit the disclosed technique.

### Embodiment

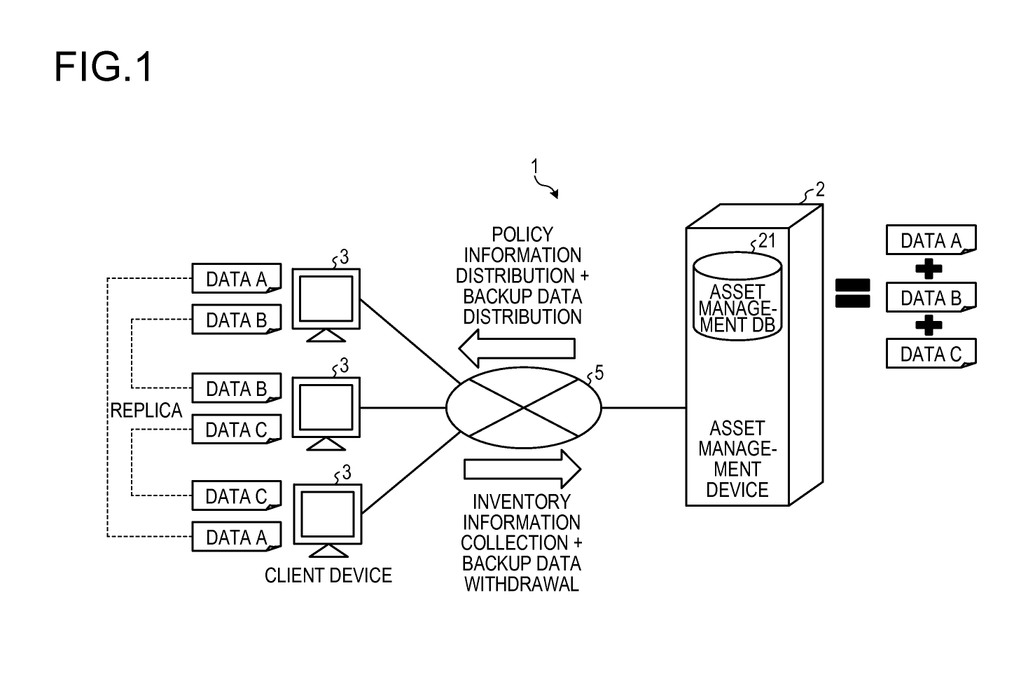

First, an asset management system according to an embodiment will be described. FIG. 1 is a view illustrating an asset management system according to an embodiment. As illustrated in FIG. 1, an asset management system 1 includes an asset management device 2 and three client devices 3. The asset management device 2 and the three client devices 3 are connected through a network 5. Further, for the convenience of description, even though only three client devices 3 are illustrated here, the asset management system 1 may include an arbitrary number of client devices 3.

The asset management device 2 has an asset management DB 21 in which asset information is stored, and divides data stored in the asset management DB 21 into three data, for example, data A, data B, and data C. In this case, the asset management device 2 divides the data into three data including data stored only in the asset management DB 21 but is not in the client devices 3. Further, the asset management device 2 distributes the data as backup data so as to arrange the data A and the data B in a first client device 3, arrange the data B and the data C in a second client device 3, and arrange the data B and the data C in a third client device 3.

Accordingly, the asset management device 2 withdraws the backup data from the client device 3 to restore the asset management DB 21. Further, the asset management device 2 distributes and arranges the backup data in two client devices 3. Accordingly, even when the backup data is not withdrawn from some of the client devices 3, the asset management device 2 may restore the asset management DB 21. Further, for the convenience of description, even though it has been described that backup data is distributed and arranged in two client devices 3, the asset management device 2 may distribute and arrange backup data in an arbitrary number of client devices 3.

The asset management device 2 distributes the backup data when the policy information is distributed to the client device 3, and withdraws the backup data when the inventory information is collected. Therefore, the asset management device 2 may distribute and withdraw the backup data with a less overhead.

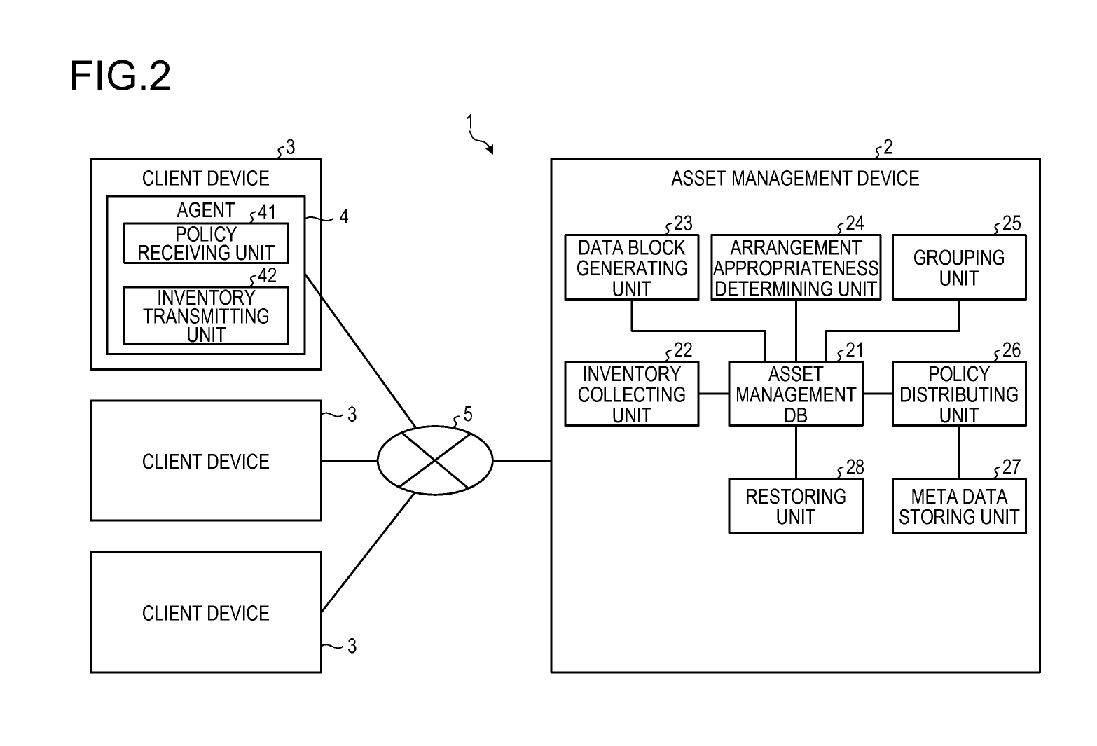

Next, a configuration of the asset management system 1 according to the embodiment will be described. FIG. 2 is a view illustrating a configuration of the asset management system 1 according to an embodiment. As illustrated in FIG. 2, the asset management device 2 includes an asset management DB 21, an inventory collecting unit 22, a data block generating unit 23, an arrangement appropriateness determining unit 24, a grouping unit 25, a policy distributing unit 26, a meta data storing unit 27, and a restoring unit 28. Further, in the client device 3, an agent 4 operates.

The asset management DB 21 has nine tables and stores asset information using the tables. Specifically, the asset management DB 21 has an inventory information table, a policy information table, a license information table, a distributed software information table, a login account information table, and a software implementation detecting condition table. The asset management DB 21 further includes an arrangement appropriateness table, a grouping table, and a restoration prohibition table.

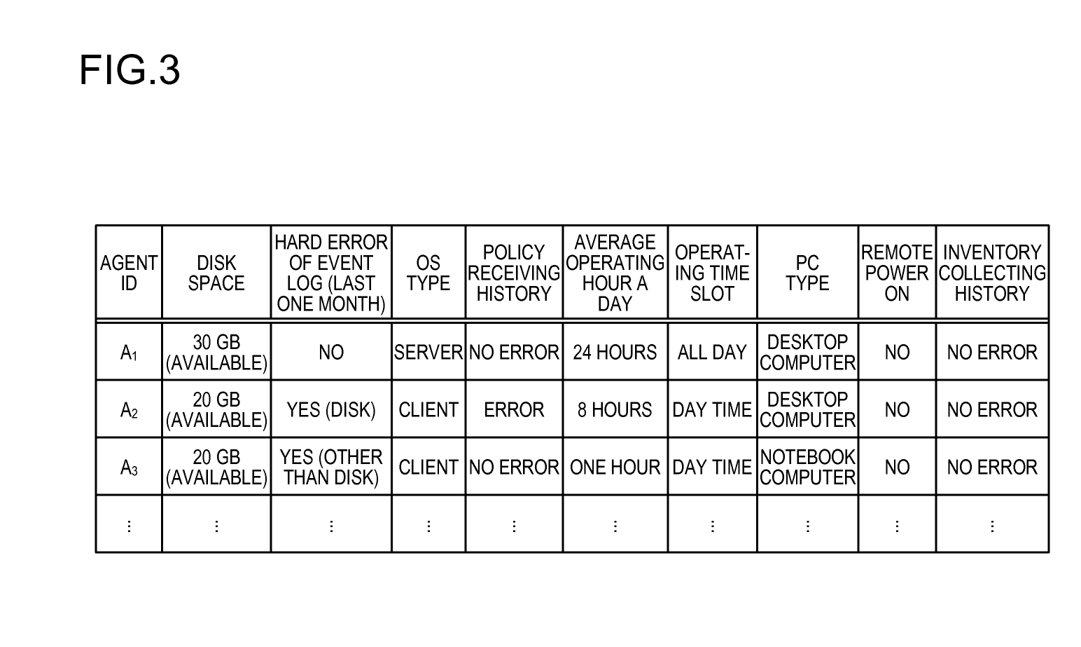

The inventory information table stores inventory information collected by the agent 4 for every client device. FIG. 3 is a view illustrating an example of the inventory information table. As illustrated in FIG. 3, the inventory information includes an agent ID, a disk space, a hard error of an event log, an OS type, a policy receiving history, an average operating hour a day, an operating time slot, a PC type, remote power on, and an inventory collecting history.

The agent ID is an identifier which identifies an agent 4 operating in the client device 3. The disk space is a space of a hard disk drive (HDD) device which is provided in the client device 3. The hard error of the event log indicates whether there is an error in the hardware within last one month. The OS type indicates a type of OS which operates in the client device 3. The policy receiving history indicates whether an error occurs when the policy information is received. The average operating hour a day is an average time when the client device 3 operates a day. The operating time slot indicates a time slot when the client device 3 operates. The PC type indicates a type of client device 3. The remote power ON indicates whether there is a remotely manipulating function of a power supply. The inventory collecting history indicates whether an error occurs when the inventory information is collected.

For example, as for the client device 3 in which an agent 4 whose agent ID is A₁ operates, a space of the HDD device is 30 GB (giga byte) which is sufficient, so that there is no error of the hardware within last one month, and an operating OS is a server. Further, as for the client device 3, an error does not occur when the policy information is received, an average operating hour a day is 24 hours, an operating time slot is a whole day, and the type of device is a desktop computer. Further, as for the client device 3, the remotely manipulating function of the power supply is not provided and an error does not occur when the inventory information is collected.

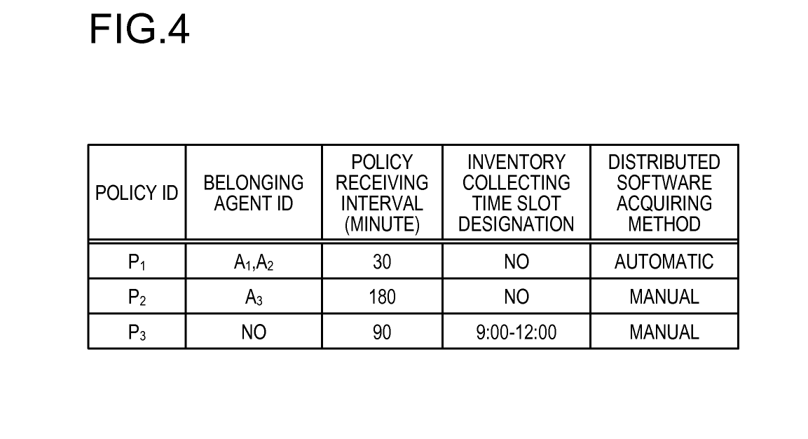

The policy information table stores information on policies which are distributed to the client device 3 for every policy. FIG. 4 is a view illustrating an example of the policy information table. As illustrated in FIG. 4, the policy information includes a policy ID, a belonged agent ID, a policy receiving interval, inventory collecting time slot designation, and a distributed software acquiring method.

The policy ID is an identifier which identifies a policy. The belonged agent ID is an agent ID of an agent 4 to which the policy is distributed. The policy receiving interval is an interval by which the agent 4 receives the policy information. The inventory collecting time slot designation indicates a time slot when the inventory information is collected. The distributed software acquiring method indicates whether the distributed software is automatically or manually acquired.

For example, since a policy whose identifier is P1 is distributed to agents 4 whose agent IDs are A1 and A2, the policy is received by the agent 4 at every 30 minutes, the time slot when the inventory information is collected is not designated, and automatic acquirement of the distributed software is designated.

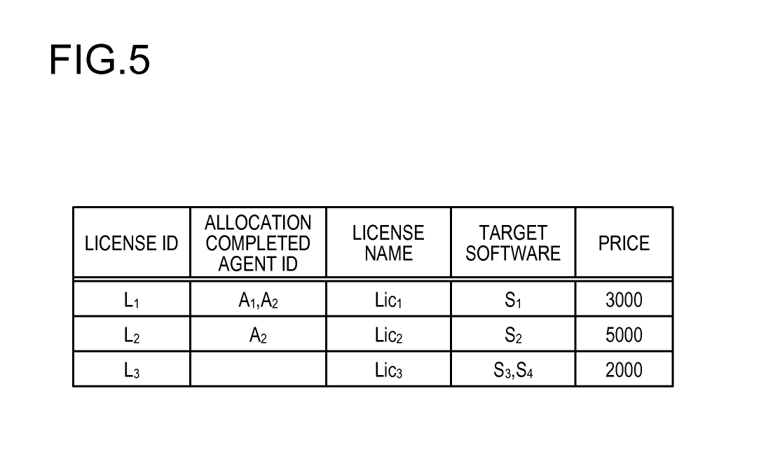

The license information table stores license information of licensed software for every license. FIG. 5 is a view illustrating an example of the license information table. As illustrated in FIG. 5, the license information includes a license ID, an allocation completed agent ID, a license name, a target software, and a price.

The license ID is an identifier which identifies a license. The allocation completed agent ID is an agent ID of the agent 4 to which a license is allocated. The license name is a name attached to a license. The target software indicates software to be licensed. The price indicates a price of the license.

For example, a license whose identifier is L1 is allocated to agents 4 whose agent IDs are A1 and A2. A name of the license is Lic1, the software to be licensed is S1, and the price of the license is 3000 Japanese Yen (¥).

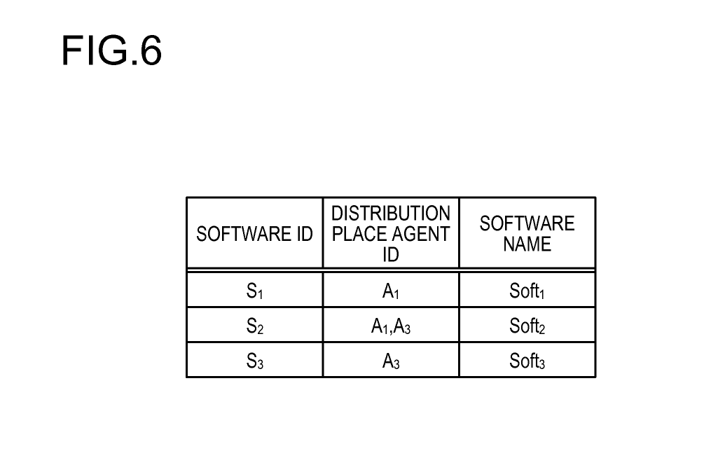

The distributed software information table stores distributed software information which is information on the software distributed to the agent 4 for every software. FIG. 6 is a view illustrating an example of the distributed software information table. As illustrated in FIG. 6, the distributed software information includes a software ID, a distribution place agent ID, and a software name.

The software ID is an identifier which identifies software. The distribution place agent ID is an agent ID of the agent 4 where the software is distributed. The software name is a name of software.

For example, software whose identifier is S1 is distributed to an agent 4 whose agent ID is A1. The name of the software is Soft1.

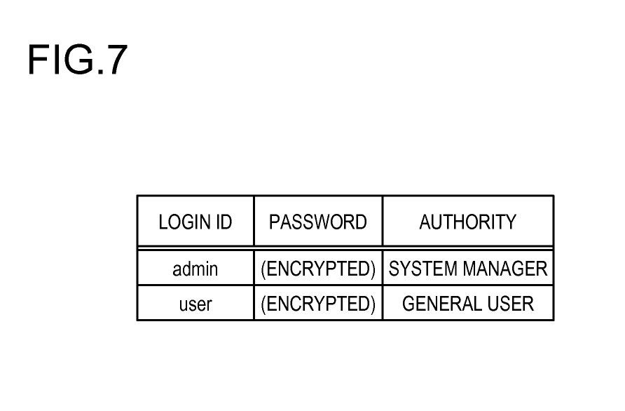

The login account information table stores login account information which is information on a login account for every account. FIG. 7 is a view illustrating an example of the login account information table. As illustrated in FIG. 7, the login account information includes a login ID, a password, and an authority.

The login ID is an identifier which is used by a user when an information communication system having the client device 3 and the network 5 is used. The password is a character string corresponding to the login ID and is used to authenticate a user. The password is stored to be encrypted. The authority indicates a manipulation which is performed on the information communication system by the user and a system manager is permitted to perform all of the manipulations on the information communication system and a general user may perform a limited manipulation. For example, a login account whose identifier is admin is permitted to perform all manipulations on the information communication system.

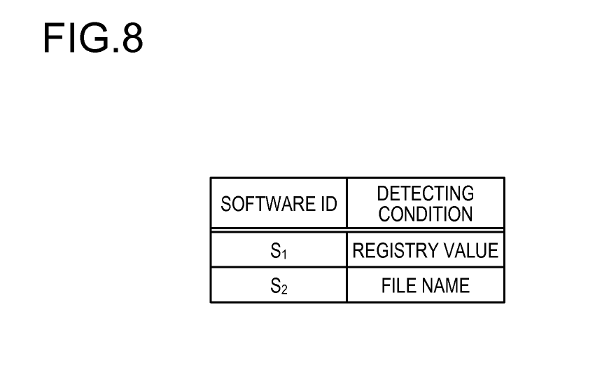

The software implementation detecting condition table stores information on a detecting condition of software which is implemented in the client device 3 for every software. FIG. 8 is a view illustrating an example of the software implementation detecting condition table. As illustrated in FIG. 8, information of the detecting condition of the software includes a software ID and a detecting condition. The detecting condition includes a registry value and a file name. Further, information combining the login account information, the software, and the software implementation detecting condition is system information.

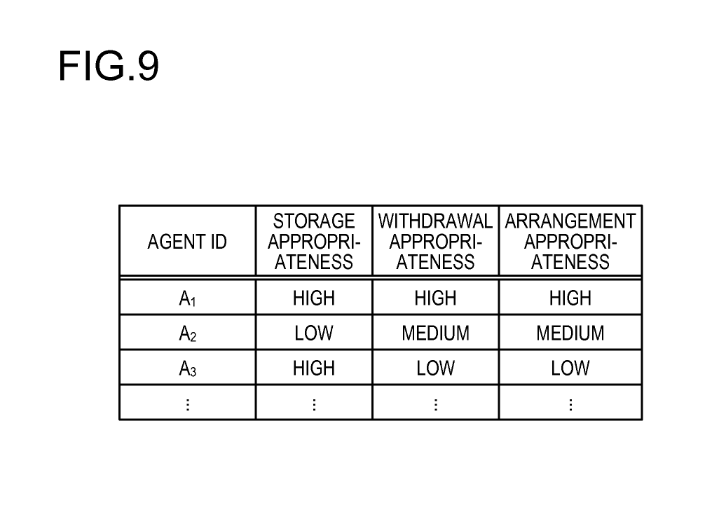

The arrangement appropriateness table stores information on appropriateness as an arrangement place of backup data of the client device 3 for every agent 4. FIG. 9 is a view illustrating an example of the arrangement appropriateness table. As illustrated in FIG. 9, information on appropriateness includes the agent ID, storage appropriateness, withdrawal appropriateness, and arrangement appropriateness.

The storage appropriateness indicates an appropriateness of the agent 4 as a storing place of the backup data. The withdrawal appropriateness indicates an appropriateness of the agent 4 when the backup data is withdrawn. The arrangement appropriateness indicates an appropriateness of the agent 4 as the arrangement place of the backup data by combining the storage appropriateness and the withdrawal appropriateness.

For example, as for the agent 4 whose identifier is A1, an appropriateness as a storing place of the backup data is high, an appropriateness when the backup data is withdrawn is high, and an appropriateness as an arrangement place of the backup data is also high. Further, details of the storage appropriateness, the withdrawal appropriateness, and the arrangement appropriateness will be described below.

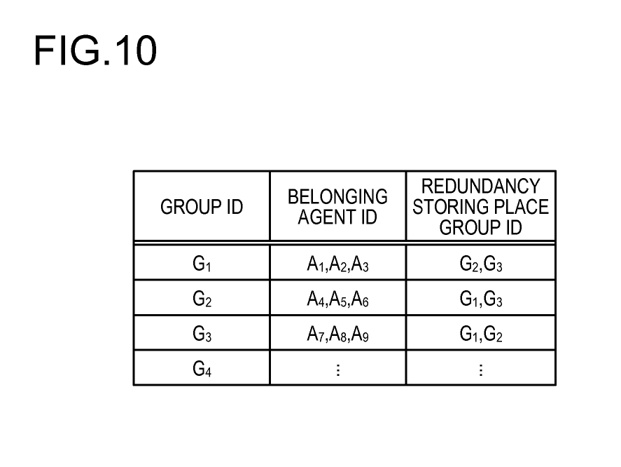

The grouping table stores information grouping the agents 4 for every group. The asset management device 2 generates one data block for each agent 4, and data blocks of the agents 4 which belong to one group are combined as group data to be backup. FIG. 10 is a view illustrating an example of the grouping table. As illustrated in FIG. 10, the information that groups the agent 4 includes a group ID, a belonged agent ID, and a redundancy storing place group ID.

The group ID is an identifier which identifies a group. The belonged agent ID is an agent ID of an agent 4 which belongs to the group. A redundancy storing place group ID indicates a group in which the group data is redundantly stored. The group data is stored in each agent 4 which belongs to the group and also redundantly stored in each agent 4 which belongs to the redundancy storing group.

For example, identifiers of agents 4 which belong to a group having an identifier G1 are A1, A2, and A3 and group data of the group having an identifier G1 is redundantly stored in the agent 4 which belongs to the groups having identifiers G2 and G3, respectively. That is, the group data of the group having an identifier G1 includes a data block corresponding to the agents 4 having identifiers A1, A2, and A3, respectively. Further, the group data of the group having an identifier G1 is stored in the agents 4 having identifiers A1, A2, and A3, respectively and also redundantly stored in an agent 4 which belongs to G2 and an agent 4 which belongs to G3.

The restoration prohibition table is used so that, when the asset management device 2 restores the data and the withdrawn policy information, license information, distributed software information, and system information are updated, the updated information is not restored by later withdrawal. The restoration prohibition table stores an identifier and a type of information for every information which is prohibited to be restored, as restoration prohibition information. Further, a unit of restoration prohibition is a unit of applying an identifier for the policy information, the license information, and the distributed software information and entire system information is a unit for the system information.

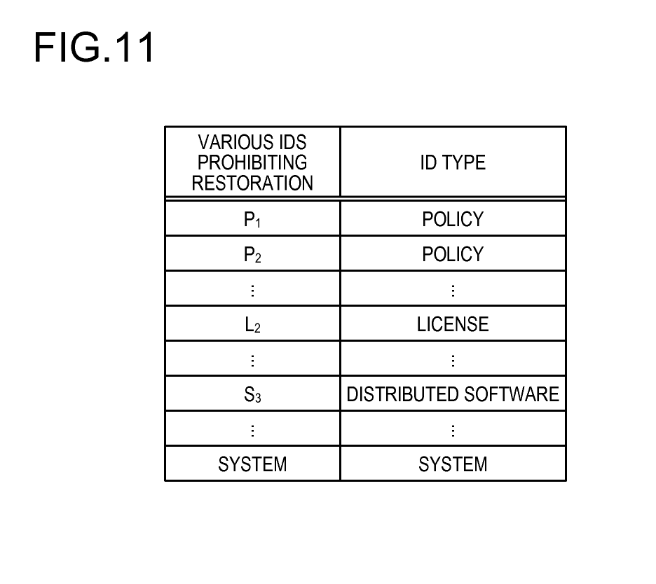

FIG. 11 is a view illustrating an example of the restoration prohibition table. As illustrated in FIG. 11, the restoration prohibition information includes various IDs which prohibit restoration and an ID type. The various IDs which prohibit restoration are identifiers which identify information prohibiting restoration and the ID type is a type of ID. For example, in FIG. 11, restoration of the policy information P1 is prohibited.

Referring back to FIG. 2, the inventory collecting unit 22 collects inventory information from individual agents 4 to store the inventory information in the inventory information table.

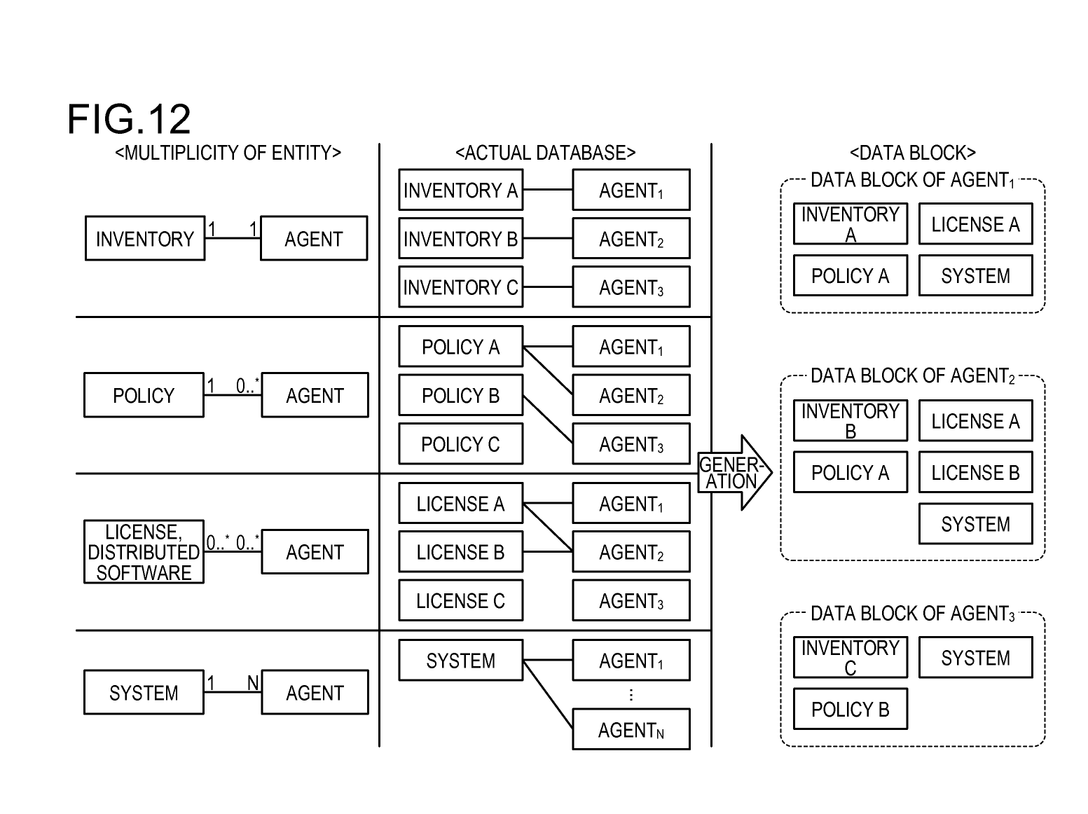

The data block generating unit 23 generates a data block for every agent 4 based on information corresponding to the agent 4. FIG. 12 is a view for explaining generation of a data block. In FIG. 12, <Multiplicity of Entity> indicates a correspondence relationship between two entities. Here, the entity refers to the agent 4, the inventory, the policy, the license, the distributed software, and the system.

As illustrated in FIG. 12, the inventory and the agent 4 have one-to-one correspondence relationship. That is, one inventory corresponds to one agent 4. The policy and the agent have one-to-majority correspondence relationship. In FIG. 12, “0 . . . *” indicates a majority including zero. That is, a policy is distributed to a plurality of agents 4 or is not distributed to any of the agents 4.

The license or the distributed software and the agent 4 have majority-to-majority correspondence relationship. That is, a license is allocated to a plurality of agents 4 or is not allocated to any of the agents 4. Further, licenses of a plurality of different software are allocated to an agent 4 or no license is allocated to the agent 4.

A distributed software is distributed to a plurality of agents 4 or is not distributed to any of the agents 4. Furthermore, a plurality of different distributed software is distributed to an agent 4 or no distributed software is distributed to the agent 4.

The system and the agent 4 have a one-to-N correspondence relationship. Here, the system is an information communication system whose asset is managed by the asset management system 1. The information communication system whose asset is managed by the asset management system 1 has N agents 4.

<Actual Database> indicates an example of a correspondence relationship. As illustrated in FIG. 12, inventory A is an inventory of agent₁, inventory B is an inventory of agent₂, and inventory C is an inventory of agent₃. Further, policy A is a policy of agent₁ and agent₂, policy B is a policy of agent₃, and policy C is not any policy of the agents 4.

License A is allocated to agent1 and agent₂, license B is allocated to agent₂, and license C is not allocated to any of the agents 4. Further, the system includes N agents 4.

When the <actual database> has the illustrated correspondence relationship, the <data block> indicates an example of a data block which is generated so as to correspond to the agent 4 by the data block generating unit 23. Since agent1 has a correspondence relationship with inventory A, policy A, license A, and a system, information of inventory A, information of policy A, information of license A, and information of the system are included in the data block which is generated so as to correspond to agent1.

Agent₂ has a correspondence relationship with inventory B, policy A, licenses A and B, and the system. Therefore, information of inventory B, information of policy A, information of licenses A and B, and information of the system are included in the data block which is generated so as to correspond to agent₂. Since agent₃ has a correspondence relationship with inventory C, policy B, and the system, information of inventory C, information of policy B, and information of the system are included in the data block which is generated so as to correspond to agent₃.

When the inventory information, the policy information, the license information, the distributed software information, or the system information is updated, the data block generating unit 23 detects the updated information to update the data block.

Referring to FIG. 2 again, the arrangement appropriateness determining unit 24 determines whether the arrangement appropriateness of the agent 4 is high, medium, or low. Here, when the arrangement appropriateness is high, the agent 4 is the most appropriate to arrange the backup data, and when the arrangement appropriateness is low, the agent 4 is the least appropriate to arrange the backup data.

The grouping unit 25 groups the agents 4 in accordance with the arrangement appropriateness determined by the arrangement appropriateness determining unit 24. The grouping unit 25 groups the agents 4 so as to uniformize the arrangement appropriateness between groups as much as possible. Further, the grouping unit 25 creates group data which is stored by the agent 4 belonging to the group from the data block.

The agent 4 belonging to the group stores all of the data blocks corresponding to members of the group as group data. Therefore, each of the agents 4 belonging to the group stores the same data. Further, the agent 4 belonging to the group redundantly stores several group data of another group.

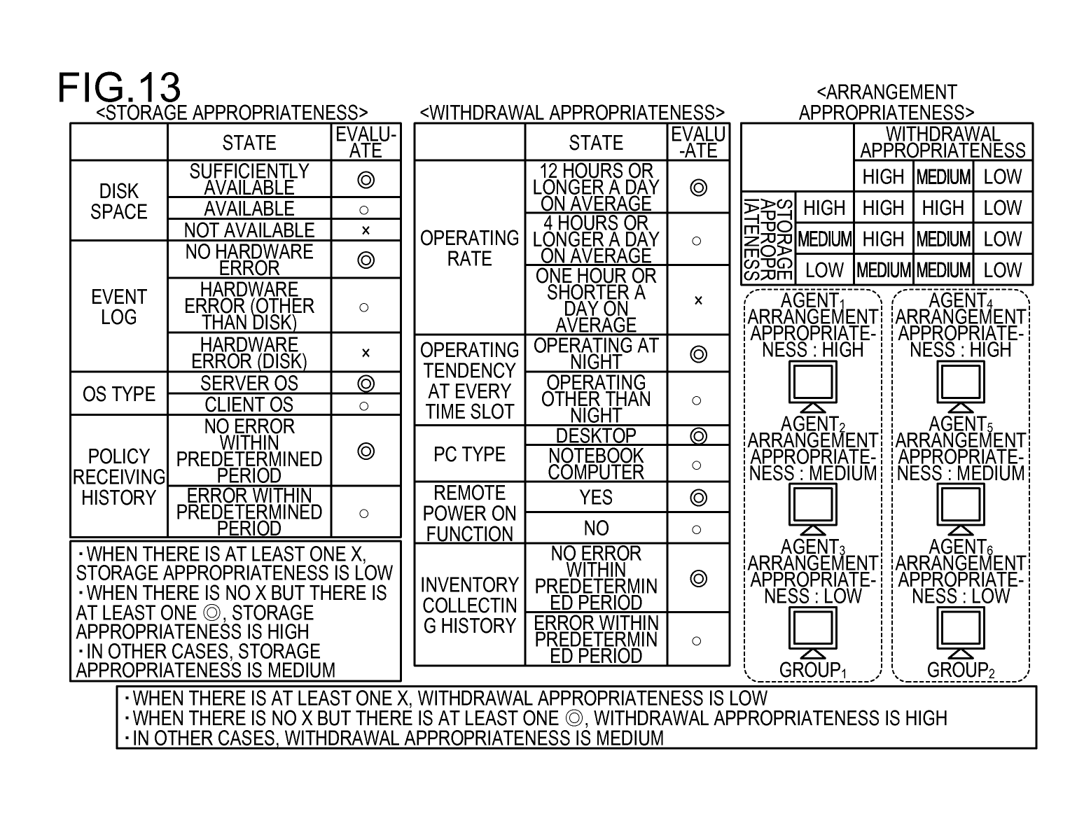

FIG. 13 is a view for explaining determination of arrangement appropriateness and generation of an agent group. As illustrated in FIG. 13, the arrangement appropriateness determining unit 24 evaluates the storage appropriateness of the agent 4 based on four items including a disk space, an event log, an OS type, and a policy receiving history. Specifically, the arrangement appropriateness determining unit 24 evaluates each item to be very appropriate (⊚), appropriate (◯) and not appropriate (x). For example, the arrangement appropriateness determining unit 24 evaluates that the disk space is very appropriate when the disk space is sufficient, evaluates that the disk space is appropriate when the disk space has a room, and evaluates that the disk space is not appropriate when the disk space does not have a room.

When there is at least one item which is evaluated to be not appropriate, the arrangement appropriateness determining unit 24 evaluates that the storage appropriateness is low, when there is an item which is evaluated to be very appropriate because there is no item which is evaluated to be not appropriate, the storage appropriateness is evaluated to be high and in other cases, the storage appropriateness is evaluated to be medium. Further, here, even though the arrangement appropriateness determining unit 24 evaluates the storage appropriateness of the agent 4 based on the four items including a disk space, an event log, an OS type, and a policy receiving history, the storage appropriateness may be evaluated using other items.

The arrangement appropriateness determining unit 24 evaluates withdrawal appropriateness of the agent 4 based on five items including an operating rate, an operating tendency at every time slot, the PC type, a remote power-on function, and an inventory collecting history. The arrangement appropriateness determining unit 24 evaluates each item to be very appropriate (⊚), appropriate (◯) and not appropriate (x) with respect to the withdrawal appropriateness. For example, when an operating time is 12 hours or longer a day on average, the arrangement appropriateness determining unit 24 evaluates that the operating rate is very appropriate. When the operating time is 4 hours or longer and shorter than 12 hours a day on average, the arrangement appropriateness determining unit 24 evaluates that the operating rate is appropriate. Further, when the operating time is one hour or shorter a day on average, the arrangement appropriateness determining unit 24 evaluates that the operating rate is not appropriate.

When there is at least one item which is evaluated to be not appropriate, the arrangement appropriateness determining unit 24 evaluates that the withdrawal appropriateness is low, when there is an item which is evaluated to be very appropriate because there is no item which is evaluated to be not appropriate, the withdrawal appropriateness is evaluated to be high and in other cases, the withdrawal appropriateness is evaluated to be medium. Further, here, even though the arrangement appropriateness determining unit 24 evaluates withdrawal appropriateness of the agent 4 based on five items including an operating rate, an operating tendency at every time slot, a PC type, a remote power-on function, and an inventory collecting history, the withdrawal appropriateness may be evaluated using other items.

The arrangement appropriateness determining unit 24 determines the arrangement appropriateness in accordance with the storage appropriateness and the withdrawal appropriateness. Specifically, when the withdrawal appropriateness is low, the arrangement appropriateness determining unit 24 determines the arrangement appropriateness to be low regardless of the storage appropriateness. Further, when the withdrawal appropriateness is medium, if the storage appropriateness is high, the arrangement appropriateness determining unit 24 determines the arrangement appropriateness to be high and if the storage appropriateness is medium or low, the arrangement appropriateness determining unit 24 determines the arrangement appropriateness to be medium. Further, when the withdrawal appropriateness is high, if the storage appropriateness is high or medium, the arrangement appropriateness determining unit 24 determines the arrangement appropriateness to be high and if the storage appropriateness is low, the arrangement appropriateness determining unit 24 determines the arrangement appropriateness to be medium.

For example, when arrangement appropriateness of agent₁ to agent₆ is high, medium, low, high, medium, and low, respectively, the grouping unit 25 groups agent₁ to agent₃ as group₁ and agent₄ to agent₆ as group₂.

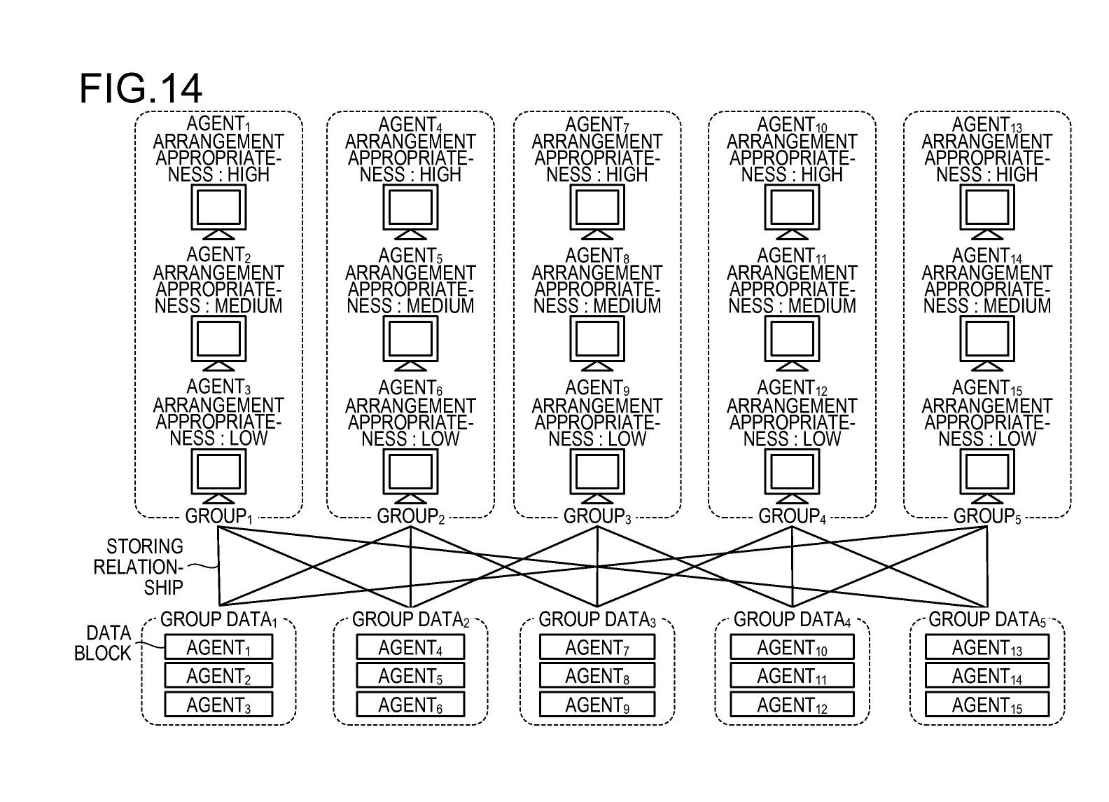

FIG. 14 is a view for explaining the agent group and the group data. FIG. 14 illustrates a case when data is backed up in five groups of group to group₅. Group₁ has agent₁ to agent₃ as members, group₂ has agent₄ to agent₆ as members, and group₃ has agent₇ to agent₉ as members. Group₄ has agent₁₀ to agent₁₂ as members, and group₅ has agent₁₃ to agent₁₅ as members.

In the example illustrated in FIG. 14, each agent 4 of group1 combines the data blocks of agent₁ to agent₃ to store the combined data blocks as group data. Further, the group data of group₁ is redundantly stored in the agents 4 belonging to group₂ and group₅. Therefore, the data blocks of agent1 are stored in nine agents 4 including three agents 4 in the group and six agents 4 in another group. Similarly, data of other agents 4 is stored in nine agents 4.

Referring to FIG. 2 again, the policy distributing unit 26 distributes the policy information to the agents 4 through the network 5. When the policy information is distributed, if the backup data which is stored by the agent 4 is updated, the policy distributing unit 26 transmits the backup data.

The grouping unit 25 regularly regroups the agent groups. When the policy is distributed after regrouping the agent groups, the policy distributing unit 26 distributes the backup data to the regrouped agent groups. When the agent group is changed, the agent 4 deletes the previous backup data and stores new backup data.

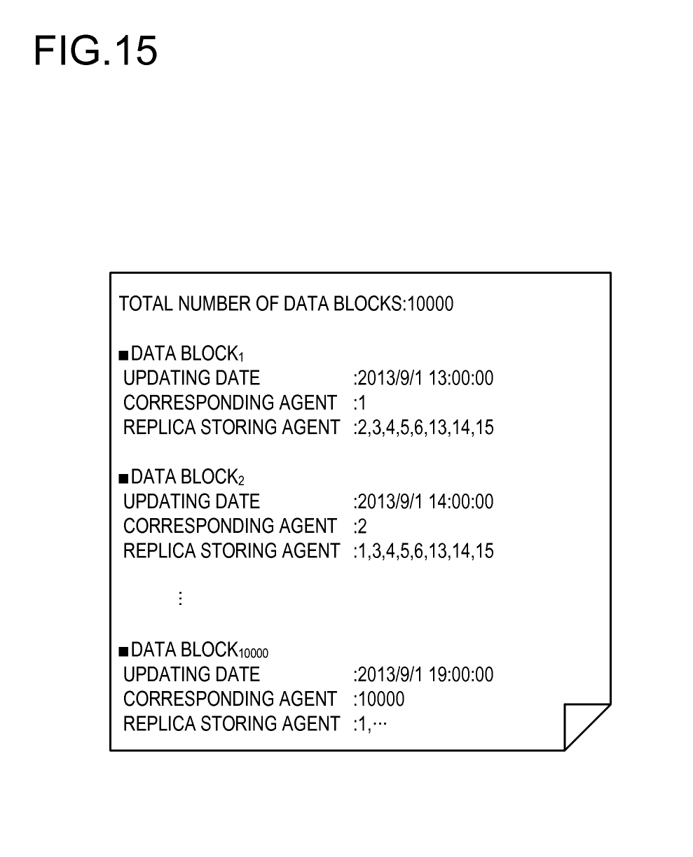

The meta data storing unit 27 stores meta data concerning the data block. FIG. 15 is a view illustrating an example of meta data. As illustrated in FIG. 15, the meta data includes the total number of data blocks and data concerning each data block. The data concerning each data block includes an updating date, a corresponding agent, and a replica storing agent.

For example, data block₁ is updated at 13:00 on Sep. 1, 2013 and a corresponding agent thereof is agent₁, and agents 4 which store replicas are agent₂ to agent₆ and agent₁₃ to agent₁. The meta data is transmitted when the policy distributing unit 26 transmits the backup data.

When failure occurs in the asset management device 2, so that the asset management device 2 is replaced or when information of the asset management DB 21 is lost, the restoring unit 28 withdraws the backup data from the agent 4 to restore the information of the asset management DB 21.

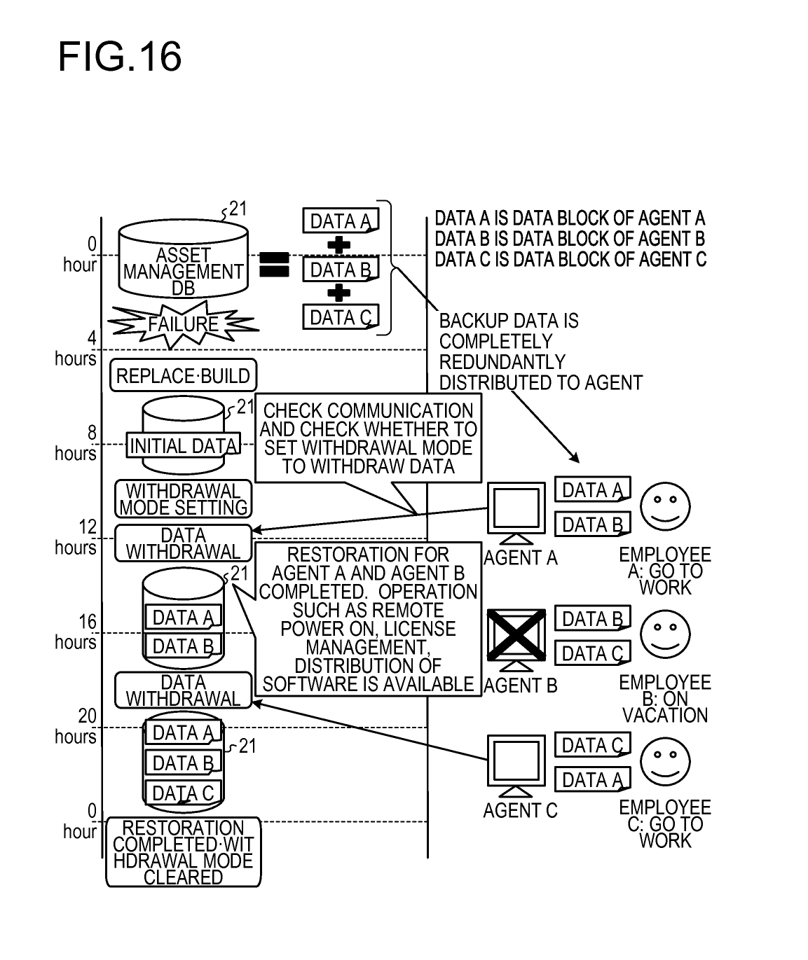

FIG. 16 is a view for explaining restoration of the asset management DB 21. FIG. 16 illustrates a case when data A to data C which are stored in the asset management DB 21 are backed up to agent A to agent C. Data A is a data block of agent A, data B is a data block of agent B, and data C is a data block of agent C. Further, here, the agent group includes only one agent.

The backup data is redundantly stored in agent A to agent C. Specifically, data A is stored in agent A and agent C, data B is stored in agent A and agent B, and data C is stored in agent B and agent C.

When failure occurs in the asset management device 2, the asset management device 2 is replaced, so that environment is built and initial data is set in the asset management DB 21. Further, the asset management device 2 is set to be a withdrawal mode by a manager.

When the agent 4 transmits the inventory information to the asset management device 2, if the asset management device 2 operates in the withdrawal mode, the agent 4 also transmits the backup data together with the inventory information. The agent 4 checks whether the asset management device 2 is in a withdrawal mode while checking the communication before transmitting the inventory.

The restoring unit 28 compares updating dates of the data block in the transmitted backup data and the data block on the asset management device 2, and restores the data block when the transmitted data block is new. Further, the restoring unit 28 displays a progress rate based on the total number of withdrawn data blocks, and clears a backup data withdrawal mode when the progress rate exceeds a threshold value.

In FIG. 16, when employee A who uses the client device 3 in which agent A operates goes to work to activate the client device 3, the restoring unit 28 may restore data A and data B. Therefore, the asset management device 2 may operate to remotely turn ON the power, manage the license, or distribute software with respect to agent A and agent B in this stage.

When employee C who uses the client device 3 in which agent C operates goes to work to activate the client device 3, the restoring unit 28 may restore data C. Accordingly, even when agent B does not operate during the vacation of employee B, the restoring unit 28 may restore the asset management DB 21 to clear the withdrawal mode.

Referring to FIG. 2 again, the agent 4 includes a policy receiving unit 41 and an inventory transmitting unit 42. The policy receiving unit 41 receives the policy information from the asset management device 2 through the network 5. Further, the policy receiving unit 41 receives the backup data when the policy information is received. The inventory transmitting unit 42 transmits the inventory information to the asset management device 2 through the network 5. When the asset management device 2 is in the withdrawal mode, the inventory transmitting unit 42 transmits the backup data together with the inventory information to the asset management device 2.

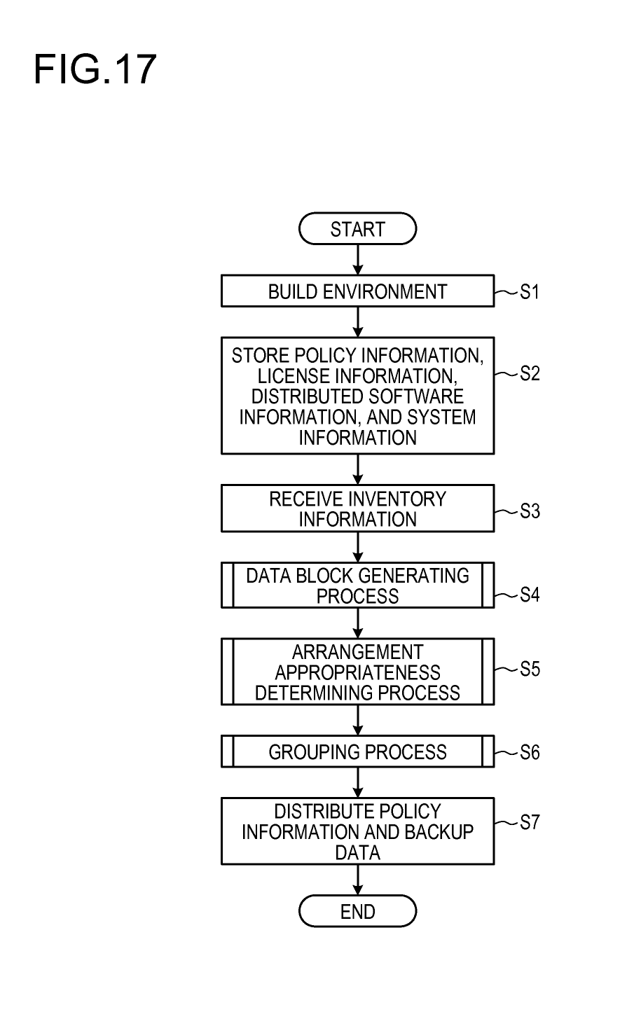

Next, a process flow when an asset management device 2 is implemented will be described. FIG. 17 is a flow chart illustrating a process flow when the asset management device 2 is implemented. As illustrated in FIG. 17, the asset management device 2 builds an environment in accordance with instruction of the manager (step S1) to store the policy information, the license information, the distributed software information, and the system information in the asset management DB 21 (step S2).

The asset management device 2 receives inventory information (step S3) to perform a data block generating process to generate a data block (step S4). The asset management device 2 performs an arrangement appropriateness determining process to determine arrangement appropriateness of agents 4 (step S5) and performs a grouping process to group the agents 4 in accordance with the arrangement appropriateness to generate group data (step S6). The asset management device 2 distributes the policy information and backup data to each agent 4 (step S7) and migrates into an operating state.

As described above, the asset management device 2 distributes the backup data to individual agents 4 when the policy information is initially distributed, thereby initially distributing the backup data.

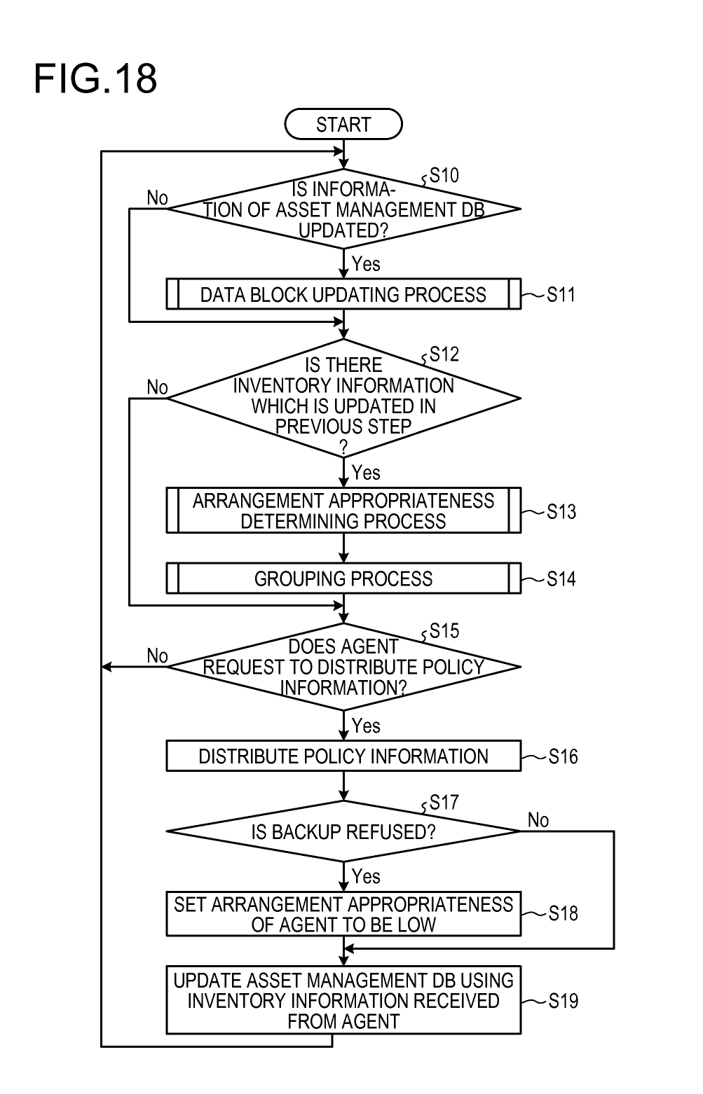

Next, a process flow when the asset management device 2 operates will be described. FIG. 18 is a flowchart illustrating a process flow when the asset management device 2 operates. As illustrated in FIG. 18, the asset management device 2 determines whether information of an asset management DB 21 is updated (step S10) and when the information is updated, performs a data block updating process to update the data block (step S11).

The asset management device 2 determines whether there is inventory information which is updated in the previous step (step S12). The determination in step S12 is performed at a predetermined time every day. When there is the updated inventory information, the asset management device 2 performs the arrangement appropriateness determining process (step S13) and performs the grouping process (step S14).

The asset management device 2 determines whether the agent 4 requests to distribute policy information (step S15) and when the policy information distribution is not requested, the asset management device 2 goes back to step S10.

In contrast, when the policy information distribution is requested, the asset management device 2 distributes the policy information (step S16). In this case, when a data block stored in the agent 4 which requests the policy information distribution is updated, the updated data block is also distributed to the agent 4.

The asset management device 2 determines whether the backup is refused (step S17) and when the backup is refused, sets the arrangement appropriateness of an agent 4 which refuses the backup to be low (step S18).

When the asset management device 2 receives the inventory information from the agent 4, the asset management device 2 updates the asset management DB 21 using the inventory information received from the agent 4 (step S19) and then goes back to step S10.

As described above, the asset management device 2 distributes backup data when the policy information is distributed to the agent 4, so that overhead in accordance with the distribution of the backup data may be reduced.

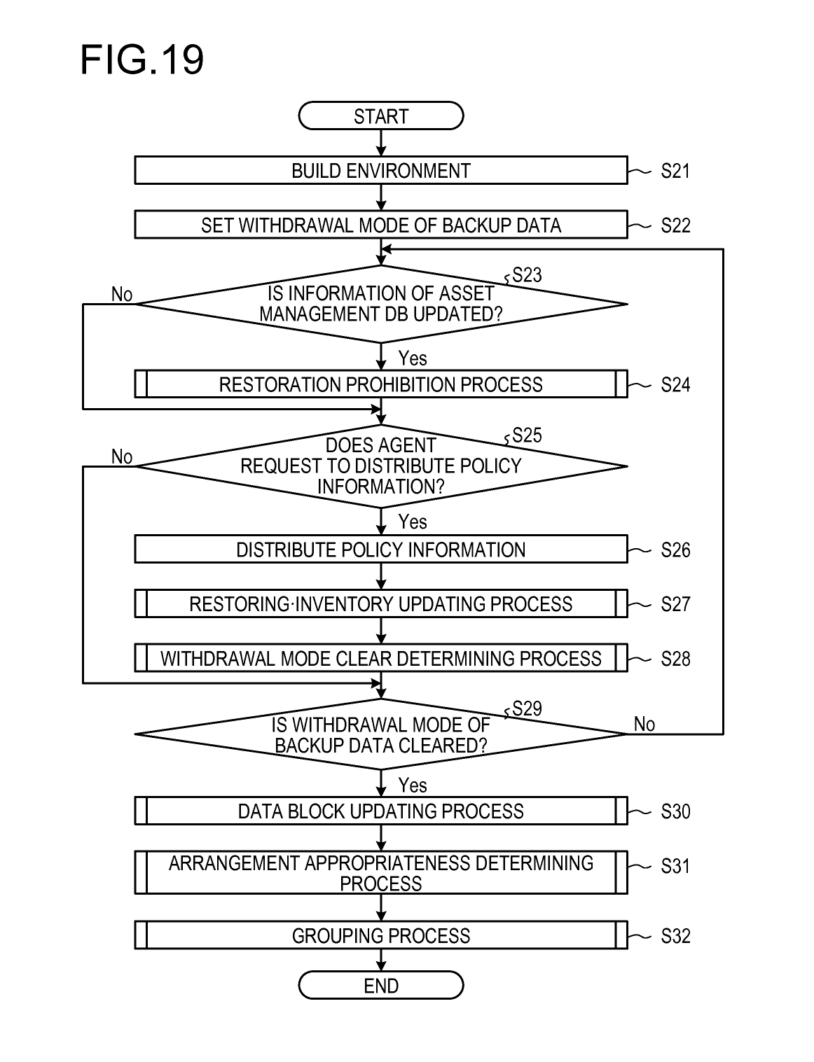

Next, a process flow at a time of restoration by the asset management device 2 will be described. FIG. 19 is a flow chart illustrating a process flow at a time of restoration by the asset management device 2. As illustrated in FIG. 19, the asset management device 2 builds an environment in accordance with an instruction of a manager (step S21) and sets a withdrawal mode of the backup data (step S22).

The asset management device 2 determines whether information of the asset management DB 21 is updated (step S23) and when the information is updated, performs a restoration prohibition process so that the updated information is not updated by the backup data (step S24).

The asset management device 2 determines whether the agent 4 requests to distribute the policy information (step S25) and when the policy information distribution is requested, the asset management device 2 distributes the policy information (step S26). The asset management device 2 performs a restoring•inventory updating process to restore the backup data and update the inventory information (step S27), and performs a withdrawal mode clear determining process to determine whether to clear the withdrawal mode (step S28).

The asset management device 2 determines whether the withdrawal mode of the backup data is cleared (step S29), and when the withdrawal mode is not cleared, goes back to step S23.

In the meantime, when the withdrawal mode is cleared, the asset management device 2 performs a data block updating process to update the data block (step S30), and performs the arrangement appropriateness determining process (step S31). The asset management device 2 performs the grouping process (step S32) and migrates into the operating state.

As described above, the asset management device 2 withdraws the backup data from the agent 4 to restore the asset management DB 21.

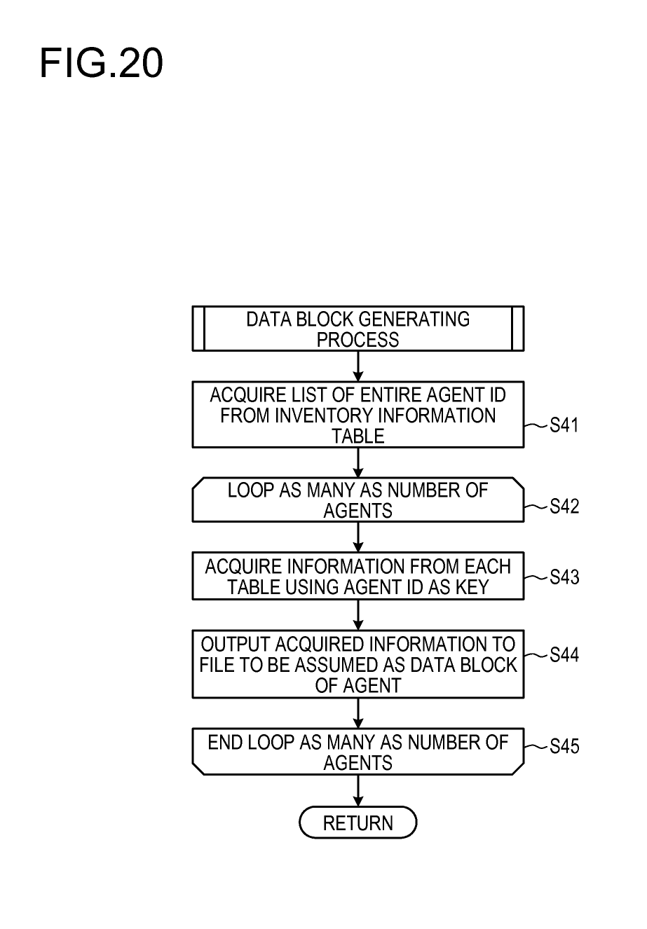

Next, a flow of a data block generating process will be described. FIG. 20 is a flowchart illustrating a flow of a data block generating process. As illustrated in FIG. 20, a data block generating unit 23 acquires a list of entire agent IDs from an inventory information table (step S41).

The data block generating unit 23 repeats processes performed between step S42 and step S45 as many as the number of agents. The data block generating unit 23 acquires information from each table using the agent ID as a key (step S43). Here, each table includes an inventory information table, a policy information table, a license information table, a distributed software information table, and a table in which system information is stored. However, as for the table in which the system information is stored, the data block generating unit 23 acquires all information without using the agent ID as a key. The data block generating unit 23 outputs the acquired information to a file to be assumed as a data block of the agent (step S44).

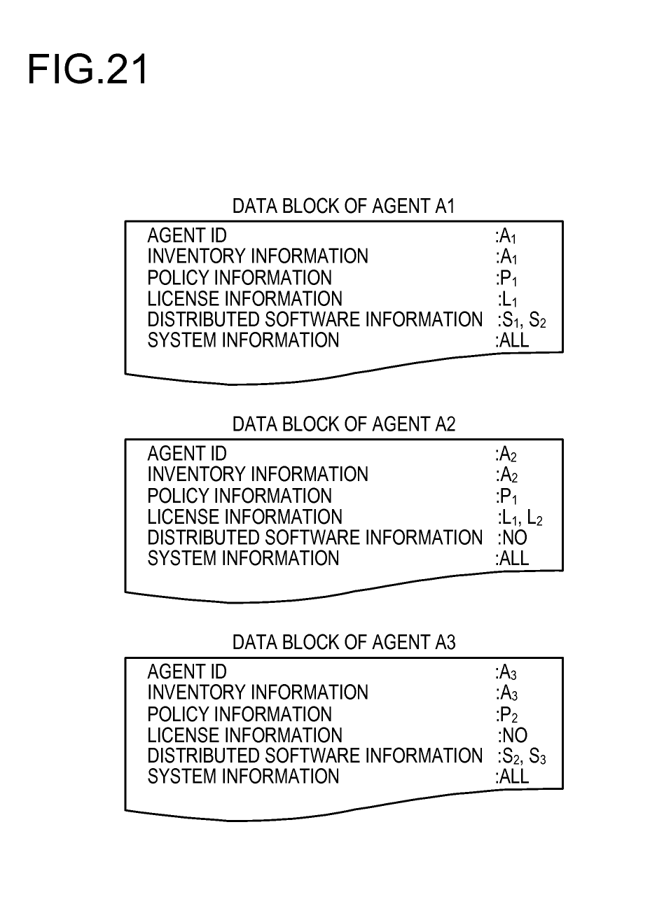

FIG. 21 is a view illustrating an example of information which is included in each data block. As illustrated in FIG. 21, each data block includes an agent ID, the inventory information, the policy information, the license information, the distributed software information, and the system information. The inventory information, the policy information, the license information, and the distributed software information are information corresponding to an agent 4 which is identified by the agent ID and the system information is all information.

For example, a data block of agent A1 includes A1 as an agent ID, inventory information of A1 as the inventory information, and information of policy P1 which is distributed to agent A1 as the policy information. Further, the data block of agent A1 includes information of license L1 which is allocated to agent A1 as the license information and information of software S1 and software S2 which are distributed to agent A1 as the distributed software information. Further, the data block of agent A1 includes all system information.

As described above, the asset management device 2 generates data blocks so as to correspond to individual agents 4, so that the backup data may be distributed and arranged in the unit of agents, not in the unit of data size. Therefore, when the asset management DB 21 is restored, even though the backup data is not withdrawn from a part of agents 4, the asset management device 2 may resume the operation only by the agent 4 which is operating.

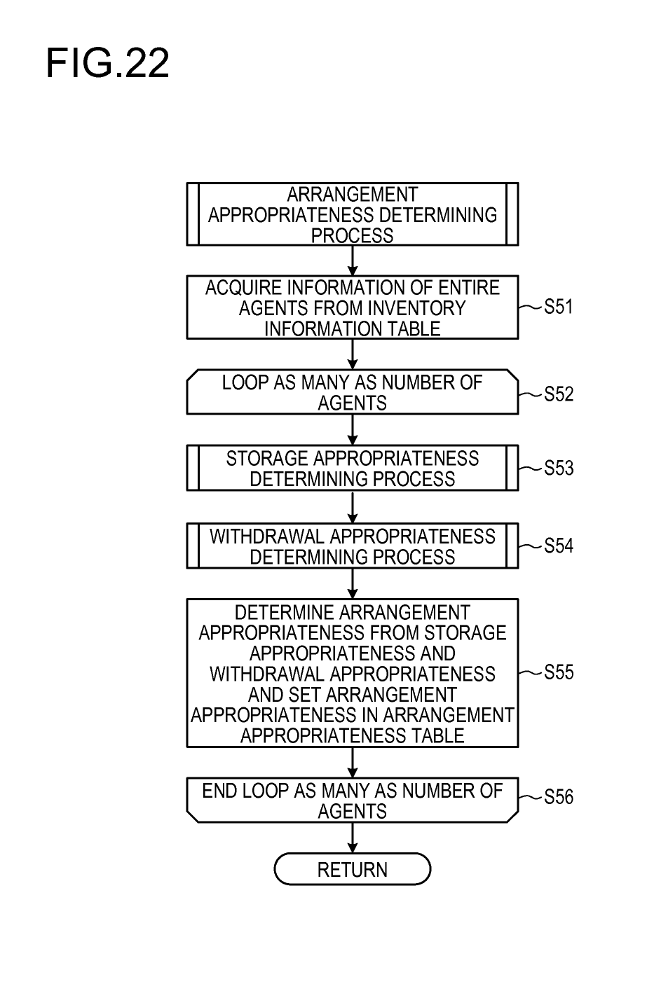

Next, a flow of an arrangement appropriateness determining process will be described. FIG. 22 is a flowchart illustrating a flow of an arrangement appropriateness determining process. As illustrated in FIG. 22, the arrangement appropriateness determining unit 24 acquires information of entire agents 4 from the inventory information table (step S51). The arrangement appropriateness determining unit 24 repeats processes performed between steps S52 and S56 as many as the number of agents.

The arrangement appropriateness determining unit 24 performs a storage appropriateness determining process to determine storage appropriateness of the agent 4 (step S53) and performs a withdrawal appropriateness determining process to determine withdrawal appropriateness of the agent 4 (step S54). The arrangement appropriateness determining unit 24 determines the arrangement appropriateness from the storage appropriateness and the withdrawal appropriateness and sets the arrangement appropriateness in an arrangement appropriateness table (step S55).

As described above, the arrangement appropriateness determining unit 24 determines the arrangement appropriateness of the agent 4 in accordance with the storage appropriateness and the withdrawal appropriateness to appropriately determine the arrangement appropriateness for respective agents 4.

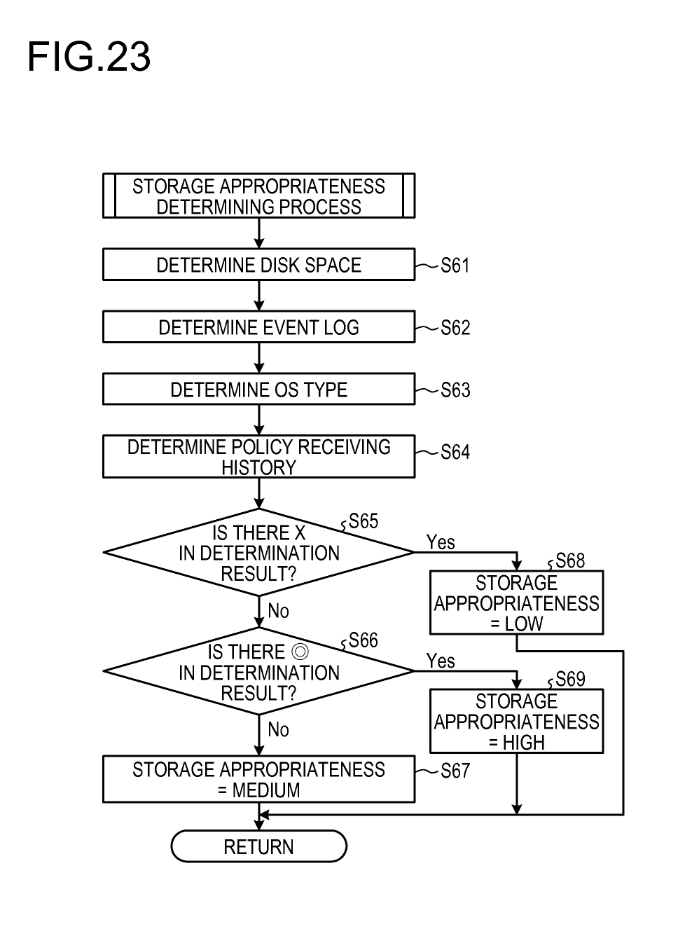

Next, a flow of a storage appropriateness determining process will be described. FIG. 23 is a flowchart illustrating a flow of a storage appropriateness determining process. As illustrated in FIG. 23, the arrangement appropriateness determining unit 24 determines a disk space (step S61) and determines an event log (step S62).

The arrangement appropriateness determining unit 24 determines an OS type (step S63) and determines a policy receiving history (step S64). The arrangement appropriateness determining unit 24 determines whether there is X in any one of the determining results of the disk space, the event log, the OS type, and the policy receiving history (step S65) and when there is X, sets the storage appropriateness to be low (step S68).

In contrast, when there is no X, the arrangement appropriateness determining unit 24 determines whether there is ⊚ in any one of determining results (step S66) and when there is ⊚, sets the storage appropriateness to be high (step S69). When there is no ⊚, the arrangement appropriateness determining unit 24 sets the storage appropriateness to be medium (step S67).

As described above, the arrangement appropriateness determining unit 24 determines the storage appropriateness based on the disk space, the event log, the OS type, and the policy receiving history to appropriately determine the storage appropriateness.

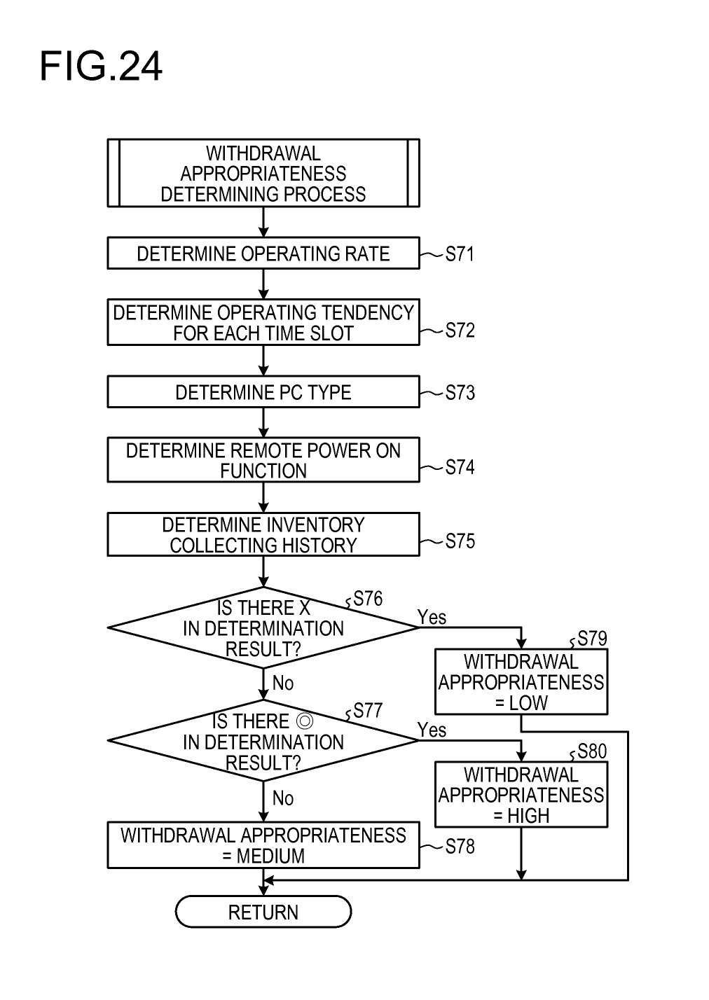

Next, a flow of a withdrawal appropriateness determining process will be described. FIG. 24 is a flowchart illustrating a flow of a withdrawal appropriateness determining process. As illustrated in FIG. 24, the arrangement appropriateness determining unit 24 determines an operating rate (step S71) and determines an operating tendency at every time slot (step S72).

The arrangement appropriateness determining unit 24 determines a PC type (step S73), determines a remote power-on function (step S74), and determines an inventory collecting history (step S75). The arrangement appropriateness determining unit 24 determines whether there is X in any one of determining results of the operating rate, the operating tendency at every time slot, the PC type, the remote power-on function, and the inventory collecting history (step S76). When there is X, the arrangement appropriateness determining unit 24 sets the withdrawal appropriateness to be low (step S79).

In contrast, when there is no X, the arrangement appropriateness determining unit 24 determines whether there is ⊚ in any one of determining results (step S77) and when there is ⊚, sets the withdrawal appropriateness to be high (step S80). When there is no ⊚, the arrangement appropriateness determining unit 24 sets the withdrawal appropriateness to be medium (step S78).

As described above, the arrangement appropriateness determining unit 24 determines the withdrawal appropriateness based on the operating rate, the operating tendency at every time slot, the PC type, the remote power-on function, and the inventory collecting history to appropriately determine the withdrawal appropriateness

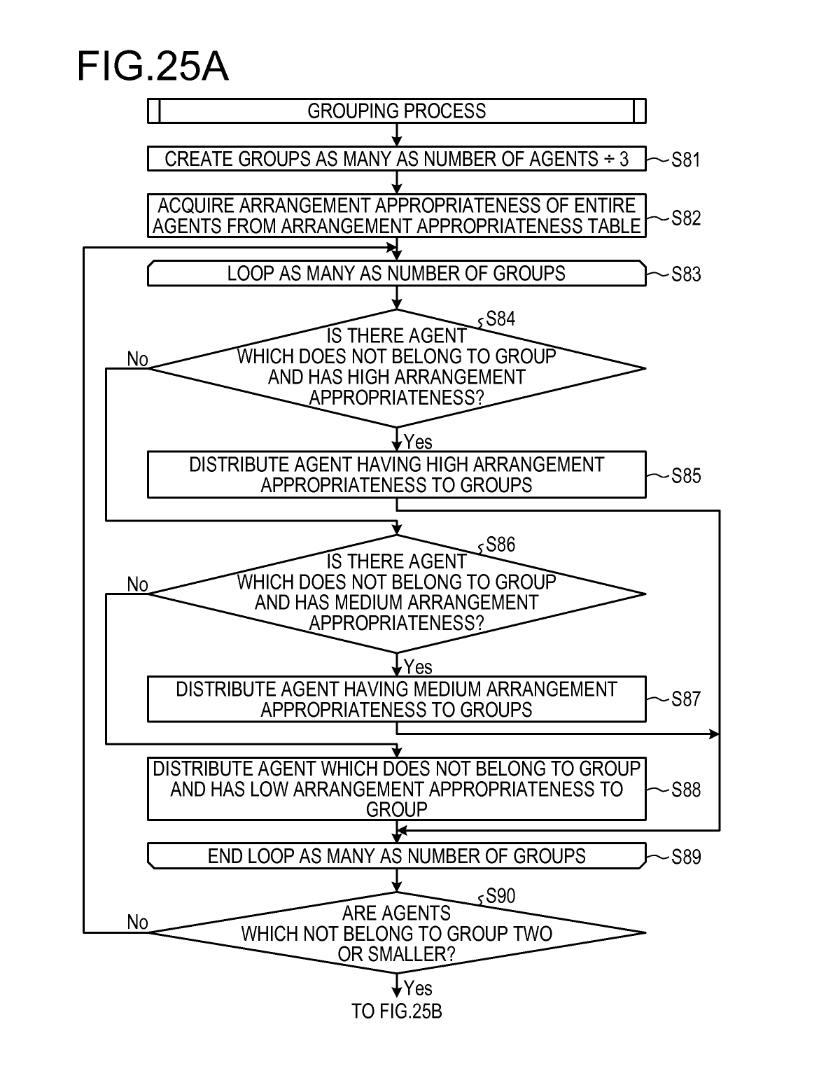

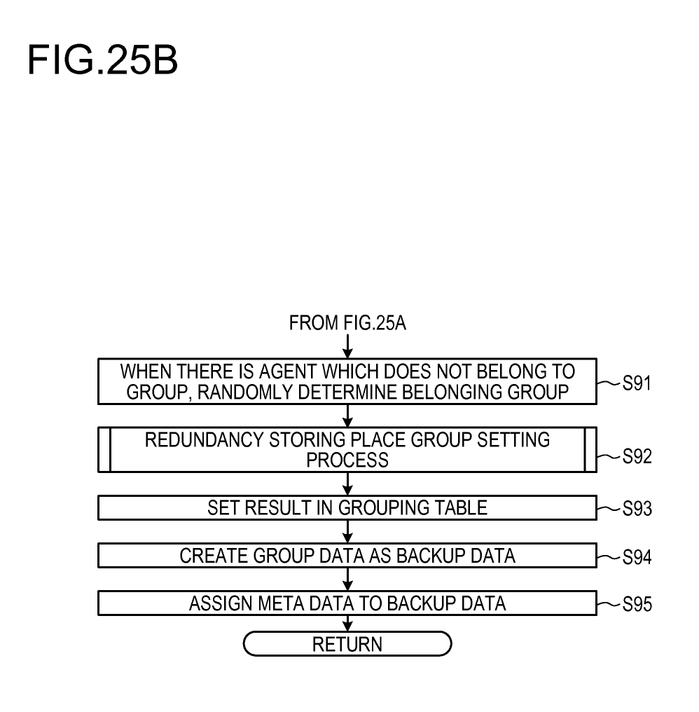

Next, a flow of a grouping process will be described. FIGS. 25A and 25B are a flowchart illustrating a flow of a grouping process. As illustrated in FIGS. 25A and 25B, a grouping unit 25 generates groups as many as the number obtained by dividing the number of agents by three (step S81). Further, here, since the number of agents which belong to each group is three, the number of agents is divided by three. However, the number of agents may be divided by any other number.

The grouping unit 25 acquires the arrangement appropriateness of the entire agents 4 from the arrangement appropriateness table (step S82), and repeats processes performed between step S83 and step S89 as many as the number of groups.

The grouping unit 25 determines whether there is an agent 4 which does not belong to a group and has high arrangement appropriateness (step S84) and when there is the agent 4, distributes an agent 4 having high arrangement appropriateness to the group (step S85). The grouping unit 25 determines whether there is an agent 4 which does not belong to a group and has medium arrangement appropriateness (step S86) and when there is the agent 4, distributes an agent 4 having medium arrangement appropriateness to the group (step S87). Further, the grouping unit 25 distributes an agent 4 having low arrangement appropriateness to the group (step S88).

The grouping unit 25 determines whether the number of agents which do not belong to the group is 2 or smaller (step S90) and when the number of agents which do not belong to the group is not 2 or smaller, goes back to step S83.

In contrast, when the number of agents which do not belong to the group is 2 or smaller and there is an agent which does not belong to the group, the grouping unit 25 randomly determines a belonging group (step S91). The grouping unit 25 sets a redundancy storage group setting process to set a group in which the backup data is redundantly stored (step S92) and sets the result in the grouping table (step S93). The grouping unit 25 generates group data as backup data (step S94) and assigns meta data to the backup data (step S95).

As described above, the grouping unit 25 distributes the agents 4 to the group sequentially from an agent having high arrangement appropriateness to uniformize the arrangement appropriateness of the group.

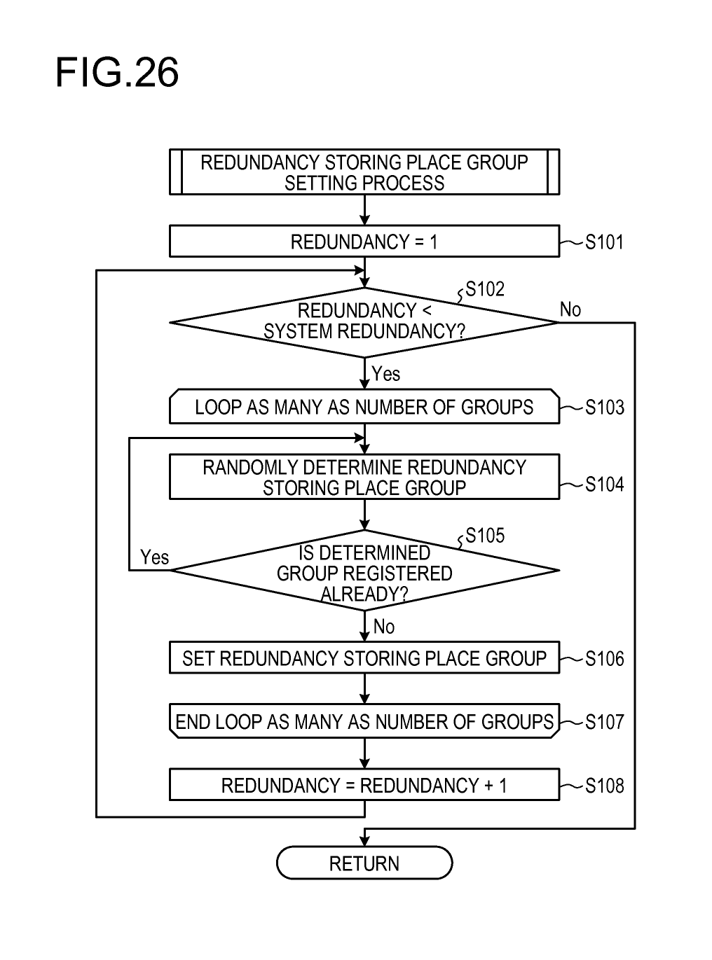

Next, a flow of a redundancy storing place group setting process will be described. FIG. 26 is a flowchart illustrating a flow of a redundancy storing place group setting process. As illustrated in FIG. 26, the grouping unit 25 initially sets a redundancy as 1 (step S101).

The grouping unit 25 determines whether a redundancy is smaller than a system redundancy (step S102) and when the redundancy is not smaller than the system redundancy, ends the process. Here, the system redundancy refers to a redundancy which is set in the asset management system 1 with respect to backup. In contrast, when the redundancy is smaller than the system redundancy, the grouping unit 25 repeats processes performed between step S103 and step S107 as many as the number of groups.

The grouping unit 25 randomly determines a redundancy storing place (step S104) and determines whether the determined group is already registered as the redundancy storing place (step S105). As a result, when the determined group is already registered, the grouping unit 25 goes back to step S104 and when the determined group is not registered, sets a redundancy storing place group (step S106).

When the processes as many as the number of groups end, the grouping unit 25 adds one to the redundancy (step S108) and goes back to step S102. As described above, the grouping unit 25 may randomly determine the redundancy storing place.

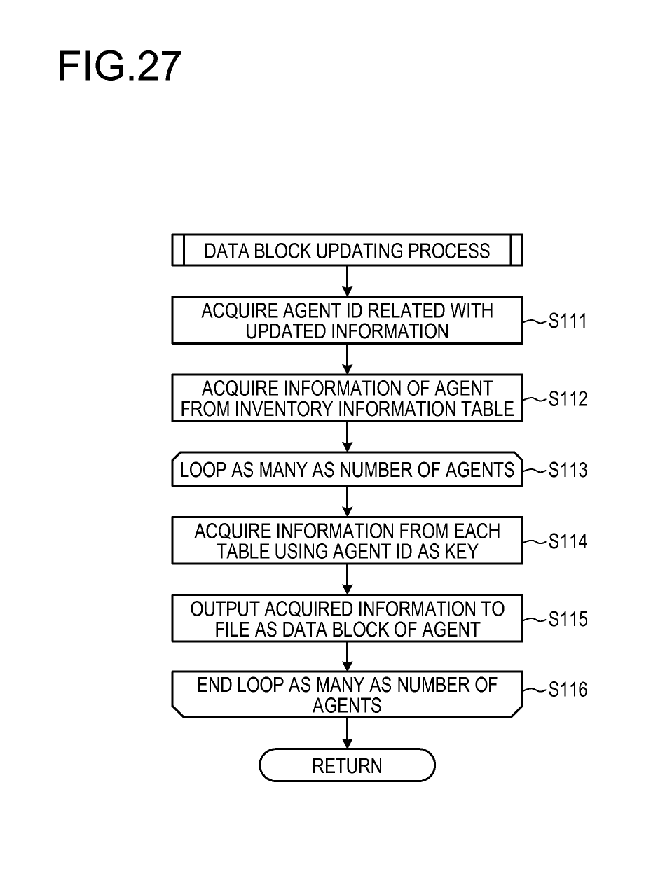

Next, a flow of a data block updating process will be described. FIG. 27 is a flowchart illustrating a flow of a data block updating process. As illustrated in FIG. 27, the data block generating unit 23 acquires an agent ID related with updated information (step S111) and acquires information of the agent 4 from the inventory information table (step S112).

The data block generating unit 23 repeats processes performed between steps S113 and S116 as many as the number of agents. The data block generating unit 23 acquires information from each table using the agent ID as a key (step S114). Here, each table includes an inventory information table, a policy information table, a license information table, a distributed software information table, and a table in which system information is stored. However, as for the table in which the system information is stored, the data block generating unit 23 acquires all information without using the agent ID as a key. The data block generating unit 23 outputs the acquired information to a file to be assumed as a data block of the agent (step S115).

As described above, the data block generating unit 23 generates a data block only for the agent 4 related with the updated information so as to efficiently update the data block.

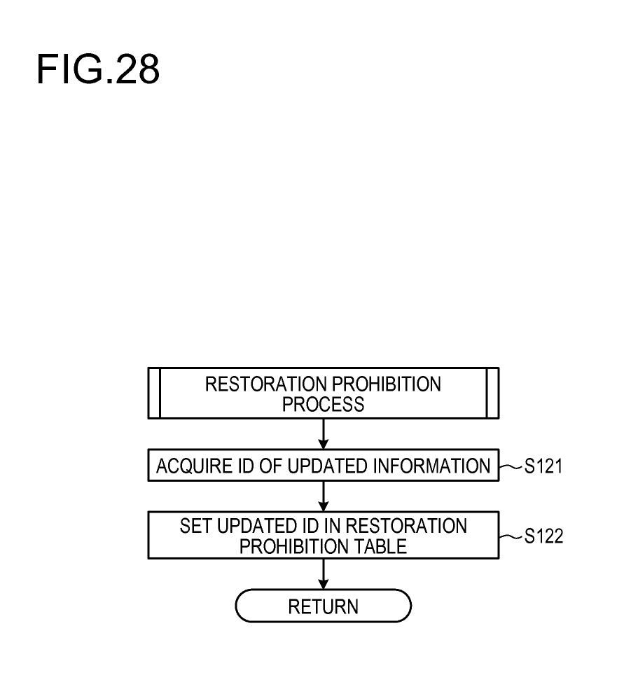

Next, a flow of a restoration prohibition process will be described. FIG. 28 is a flowchart illustrating a flow of a restore prohibition process. As illustrated in FIG. 28, a restoring unit 28 acquires an ID of the updated information (step S121).

Here, the acquired ID includes a policy ID, a license ID, a software ID, and a system. The restoring unit 28 sets the updated ID into a restoration prohibition table (step S122).

As described above, the restoring unit 28 may prevent the information which is updated during restoration from being updated by the backup data by setting the ID of the updated information into the restoration prohibition table.

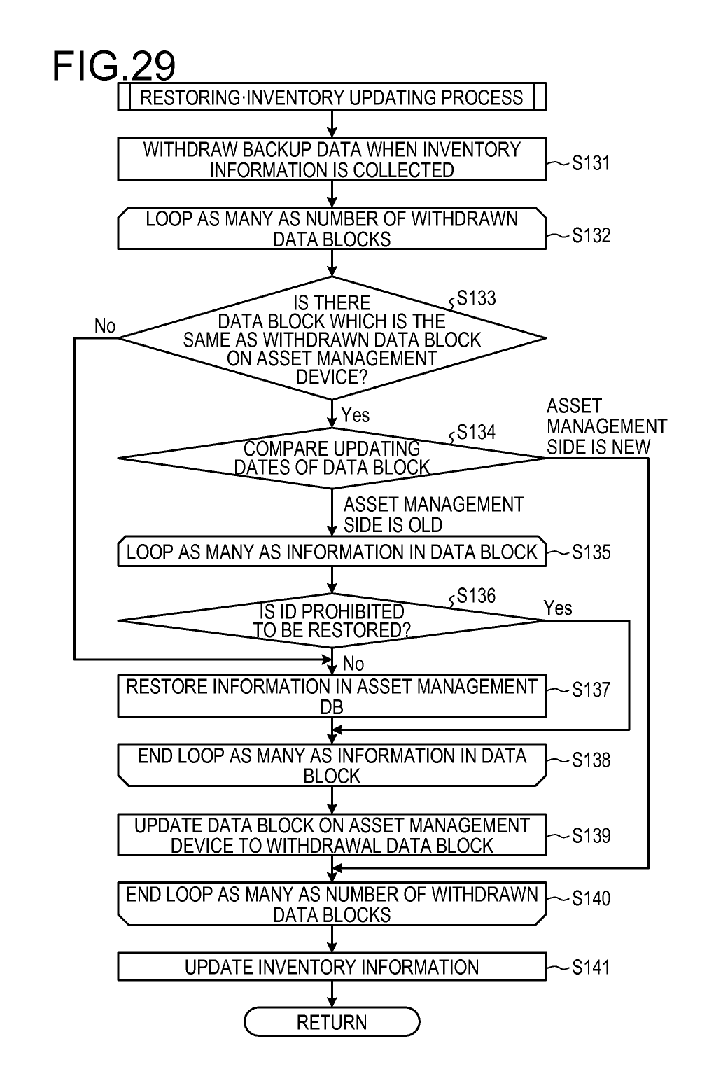

Next, a flow of a restoration•inventory updating process will be described. FIG. 29 is a flowchart illustrating a flow of a restoration•inventory updating process. As illustrated in FIG. 29, when the inventory information is collected, the asset management device 2 withdraws the backup data (step S131). Further, the restoring unit 28 repeats processes performed between step S132 and step S140 as many as the number of withdrawn data blocks.

The restoring unit 28 determines whether there is a data block which is the same as the withdrawal data block on the asset management device (step S133) and when there is no data block which is the same as the withdrawal data block, goes to step S137.

In contrast, when there is a data block which is the same as the withdrawal data block, the restoring unit 28 compares updating dates of the data block (step S134) and when a data block at the asset management device side is new, goes to step S140 and ends the processing on the data block. In contrast, when a data block at the asset management device side is old, the restoring unit 28 repeats processes performed between step S135 and S138 as many as the information in the data block.

The restoring unit 28 determines whether information ID in the data block is an ID which is prohibited to be restored (step S136) and when the restoration is not prohibited, restores the information in the asset management DB 21 (step S137).

When the repeating of processes as many as the information in the data block is completed, the asset management device 2 updates the data block on the asset management device to the withdrawal data block (step S139). When the repeating of processes as many as the number of withdrawn data blocks is completed, the asset management device 2 updates the inventory information (step S141).

As described above, the asset management device 2 prevents new data from being updated with old data by restoring the withdrawn data blocks based on the date of the data block and restoration prohibition information.

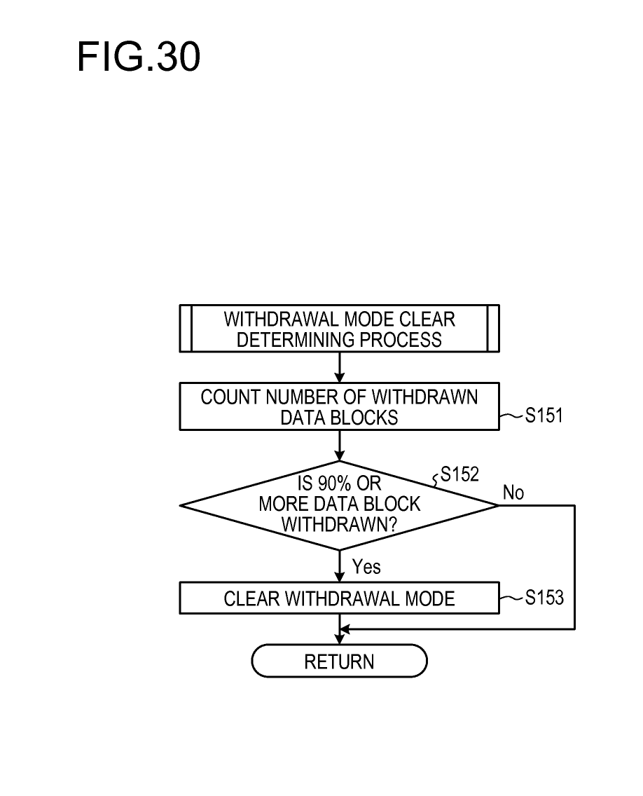

Next, a flow of a withdrawal mode clear determining process will be described. FIG. 30 is a flowchart illustrating a flow of a withdrawal mode clear determining process. As illustrated in FIG. 30, the restoring unit 28 counts the number of withdrawn data blocks (step S151).

The restoring unit 28 determines whether 90% or more data blocks are withdrawn (step S152), and when 90% or more data blocks are withdrawn, clears the withdrawal mode (step S153).

As described above, when the 90% or more data blocks are withdrawn, the restoring unit 28 clears the withdrawal mode to completely withdraw the backup data. 90% is an example and the restoring unit 28 may use other values.

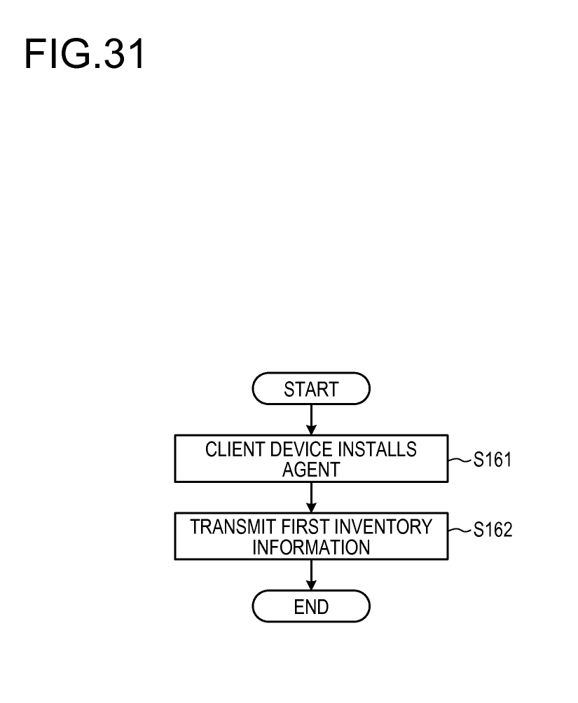

Next, a process flow when an agent is implemented will be described. FIG. 31 is a flowchart illustrating a process flow when an agent is implemented. As illustrated in FIG. 31, in accordance with an instruction of a user, a client device 3 installs the agent 4 (step S161). The agent 4 transmits first inventory information (step S162) and migrates into an operating state.

As described above, the client device 3 installs the agent 4 in accordance with the instruction of the user, so that the user may use the asset management device 2.

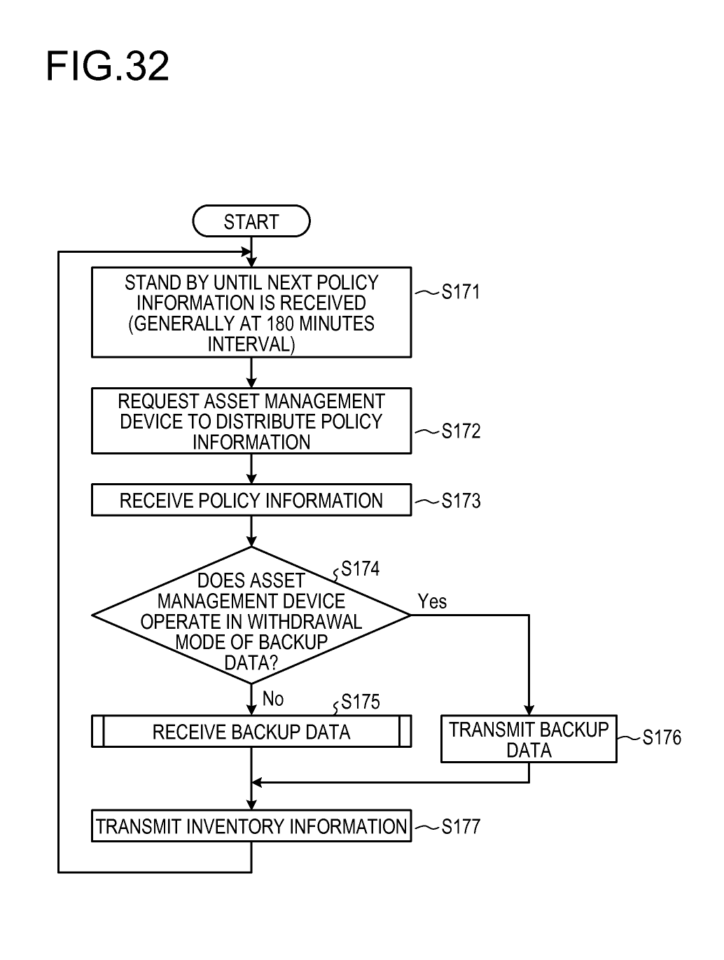

Next, a process flow when the agent 4 is operated or restored will be described. FIG. 32 is a flowchart illustrating a process flow when an agent 4 is operated or restored. As illustrated in FIG. 32, the agent 4 stands by until next policy information is received (step S171). Generally, the policy information is received at an interval of 180 minutes and the interval may be changed by a setting.

When it is time to receive the policy information, the agent 4 requests the asset management device 2 to distribute the policy information (step S172) and receives the policy information from the asset management device 2 (step S173).

The agent 4 determines whether the asset management device 2 operates in the withdrawal mode of back up data (step S174). As a result of the determination, when the asset management device 2 does not operate in the withdrawal mode, the agent 4 performs a backup data receiving process to receive backup data from the asset management device 2 (step S175). In contrast, when the asset management device 2 operates in the withdrawal mode, the agent 4 transmits the backup data to the asset management device 2 (step S176).

The agent 4 transmits the inventory information to the asset management device 2 (step S177). As described above, the agent 4 may efficiently transmit and receive backup data by transmitting and receiving the backup data when the inventory information is transmitted.

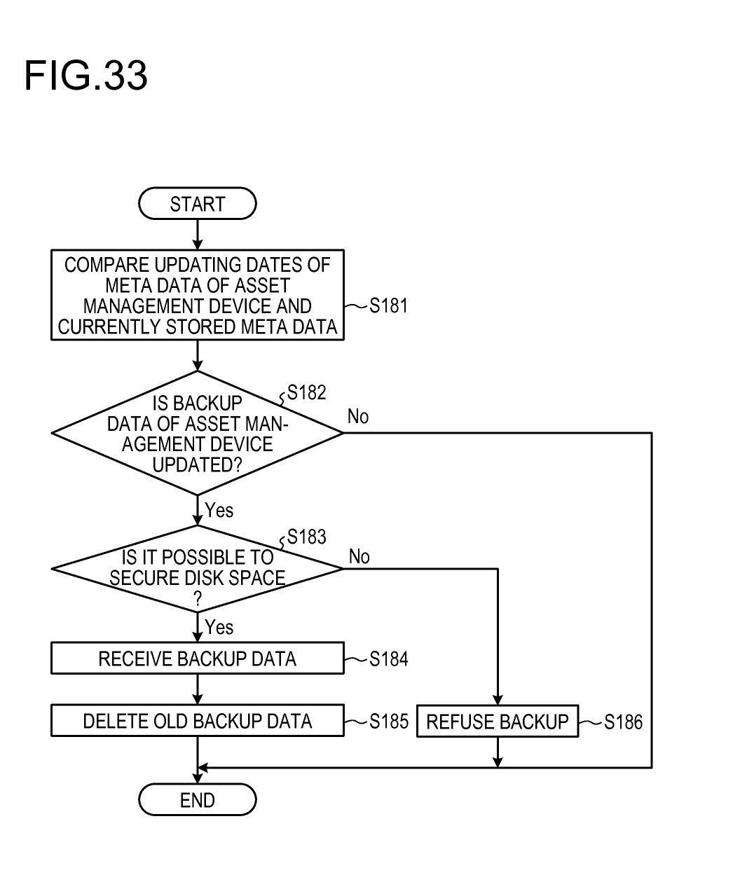

Next, a flow of a backup data receiving process will be described. FIG. 33 is a flowchart illustrating a flow of a backup data receiving process. As illustrated in FIG. 33, the agent 4 compares updating dates of the meta data of the asset management device 2 and meta data which is currently stored (step S181). Further, the agent 4 determines whether the backup data of the asset management device 2 is updated (step S182) and when the backup data is not updated, ends the process.

In contrast, when the backup data of the asset management device 2 is updated, the agent 4 determines whether a disk space is capable of being secured (step S183) and when the disk space cannot be secured, refuses backup (step S186). In contrast, when the disk space is capable of being secured, the agent 4 receives backup data (step S184) and deletes old backup data (step S185).

As described above, the agent 4 may efficiently receive backup data by determining whether the backup data is updated using the meta data.

As described above, according to the embodiment, the data block generating unit 23 generates data blocks so as to correspond to the agents 4 and the arrangement appropriateness determining unit 24 determines the arrangement appropriateness of the agents 4. The grouping unit groups the agents 4 in accordance with the arrangement appropriateness to generate the group data which is stored by the agents 4 which belong to the group from the data blocks corresponding to the agents 4. When the policy distributing unit 26 distributes the policy information, the policy distributing unit 26 transmits the group data which is stored by the agents 4 to the agents 4 together with other group data which is redundantly stored.

Accordingly, the asset management system 1 may distribute and arrange the backup information into the client device 3. Further, even when only a part of client devices 3 operate while restoring the data, the asset management system 1 may operate based on the backup data which is withdrawn from the client device 3 which is operating. The asset management system 1 may efficiently transmit the backup data to the client device 3.

According to the embodiment, the asset management device 2 withdraws the backup data when the inventory information is collected. Accordingly, the asset management system 1 may efficiently withdraw the backup data from the client device 3.

According to the embodiment, the arrangement appropriateness determining unit 24 calculates the arrangement appropriateness in accordance with the storage appropriateness indicating an appropriate degree of storing the backup data and the withdrawal appropriateness indicating an appropriate degree of withdrawing the backup data. Therefore, the asset management device 2 may appropriately determine the storage appropriateness of the client device 3.

In the embodiment, the asset management device has been described and an asset management program having the same function may be obtained by implementing a configuration of the asset management device by software. Now, a computer which executes the asset management program will be described.

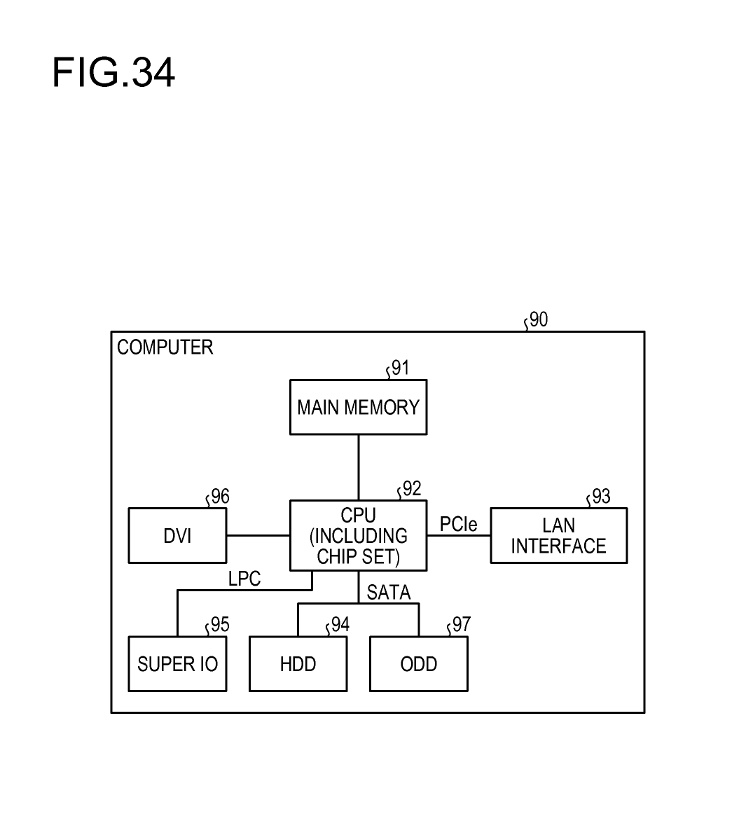

FIG. 34 is a view illustrating a hardware configuration of a computer which executes an asset management program according to an embodiment. As illustrated in FIG. 34, a computer 90 includes a main memory 91, a central processing unit (CPU) 92, a local area network (LAN) interface 93, and an HDD 94. Further, the computer 90 includes a super input/output (IO) 95, a digital visual interface (DVI) 96, and an optical disk drive (ODD) 97.

The main memory 91 is a memory in which a program or a result in the middle of execution of the program is stored. The CPU 92 is a central processing device which reads out a program from the main memory 91 and executes the program. The CPU 92 includes a chip set having a memory controller.

The LAN interface 93 is an interface which connects the computer 90 to another computer via the LAN. The HDD 94 is a disk device in which the program or data is stored and the super IO 95 is an interface which connects an input device such as a mouse or a keyboard. The DVI 96 is an interface which connects a liquid crystal display device and the ODD 97 is a device which writes data in the DVD and reads out the data from the DVD.

The LAN interface 93 is connected to the CPU 92 by a PCI express and the HDD 94 and the ODD 97 are connected to the CPU 92 by serial advanced technology attachment (SATA). The super IO 95 is connected to the CPU 92 by a low pin count (LPC).

The asset management program which is executed in the computer 90 is stored in the DVD and read out from the DVD by the ODD 97 to be installed in the computer 90. Alternatively, the asset management program is stored in a database of another computer system which is connected through the LAN interface 93 and read out from the database to be installed in the computer 90. The installed asset management program is stored in the HDD 94 and read out in the main memory 91, and executed by the CPU 92.

In the present embodiment, the asset management device 2 has been described, but the present invention is not limited thereto and may also be applied to a backup device only having a data backup function by the asset management device 2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A backup apparatus which backs up data of a management device which manages a plurality of client devices based on information from agents which correspondingly operate on the plurality of client devices, the backup apparatus comprising:
a memory; and
a processor coupled to the memory and configured to:
generate a data block related with a specific agent, from information received from the specific agent and information on a client device in which the specific agent of the asset management device operates, for each of the plurality of agents, calculates arrangement appropriateness of the plurality of client devices based on the information received from the plurality of agents, and
distribute and arranges the plurality of data blocks to the plurality of client devices in accordance with the arrangement appropriateness of the plurality of client devices.

2. The backup apparatus according to claim 1, wherein the processor arranges all data blocks related with an agent which operates in the client device in the group in each of the client devices in the group by grouping the plurality of client devices in accordance with the arrangement appropriateness.

3. The backup apparatus according to claim 1, wherein when the processor distributes policy information on management to the client device, the processor transmits a data block generated by the processor to distribute and arrange the plurality of data blocks into the plurality of client devices.

4. The backup apparatus according to claim 1, wherein when information is collected from the agent, the data blocks which are distributed and arranged by the processor are withdrawn.

5. The backup apparatus according to claim 4, wherein when the processor withdraws a part of the data blocks distributed and arranged by the processor, the management device starts to operate.

6. The backup apparatus according to claim 1, wherein the processor calculates the arrangement appropriateness in accordance with storage appropriateness indicating an appropriate degree of storing the backup data and withdrawal appropriateness indicating an appropriate degree of withdrawing the backup data.

7. A backup method by a backup apparatus having a computer which backs up data of a management device which manages a plurality of client devices based on information from agents which operate on the plurality of client devices, the method comprising:
generating a data block related with a specific agent, from information received from the specific agent and information on a client device in which the specific agent of the management device operates, for each of the plurality of agents;
calculating arrangement appropriateness of the plurality of client devices based on the information received from the plurality of agents; and
distributing and arranging the plurality of data blocks to the plurality of client devices in accordance with the arrangement appropriateness of the plurality of client devices.

8. A non-transitory, computer-readable recording medium having stored therein a program for causing a computer to back up data of a management device which manages a plurality of client devices based on information from agents which operate on the plurality of client devices, the backup program causing the processor to execute a process, the process comprising:
generating a data block related with a specific agent, from information received from the specific agent and information on a client device in which the specific agent of the management device operates, for each of the plurality of agents;
calculating arrangement appropriateness of the plurality of client devices based on the information received from the plurality of agents; and
distributing and arranging the plurality of data blocks to the plurality of client devices in accordance with the arrangement appropriateness of the plurality of client devices.
